(19) United States
(12) Patent Application Publication
(10) Pub. No.: US 2007/0107836 A1
(43) Pub. Date: May 17, 2007

(54) Processes for the production of packaging materal for transporting and storing perishable goods

(76) Inventors: Marks Raymond Gibberd, Western Australia (AU); Peter James Symons, Victoria (AU); Robert Jojn Morgan, Victoria (AU)

Correspondence Address: COOPER & DUNHAM, LLP, 1185 AVENUE OF THE AMERICAS, NEW YORK, NY, 10036, US

(21) Appl. No.: 10/581,540

(22) PCT Filed: Dec. 3, 2004
(86) PCT No.: PCT/AU04/01706

§ 371 Date: Oct. 3, 2006

(30) Foreign Application Priority Data
Dec. 3, 2003 (AU) 2003906706

(51) Int. Cl. B32B 27/32; B32B 27/30

(52) U.S. Cl. 156/244.11; 428/34.2; 428/411.1; 428/523; 428/522; 428/213; 428/341

(57) ABSTRACT

This invention relates to packaging materials comprising a water-impermeable outer layer bonded to a water-absorbent layer and having an inner layer that is water vapour-permeable, and to processes for the manufacture thereof. The invention also provides for the storage and/or transport of perishable goods, and in particular for the storage and transport of horticultural produce such as fruit, vegetables and cut flowers. The present invention also provides a method of regulating the O₂ content in the environment surrounding packaged perishable goods.

### FIELD OF THE INVENTION

The present invention relates to packaging material, and processes for the production thereof, for the storage and/or transport of perishable goods, and in particular for the storage and transport of horticultural produce such as fruit, vegetables and cut flowers. The present invention also relates to methods of regulating the O₂ content in the environment surrounding packaged perishable goods.

### BACKGROUND OF THE INVENTION

Many food products are perishable, namely they begin to deteriorate after they are harvested through moisture loss and microbiological, physiological or chemical spoilage. Consequently, perishable goods are often cooled as soon as possible after harvesting and packaged so as to prevent and/or retard such deterioration. This is particularly important where goods are not for immediate or imminent consumption, and especially where they are destined to be distributed over long distances or exported overseas.

The atmosphere inside a package of horticultural produce constantly changes as gases and moisture are produced or consumed during metabolic processes. The produce will continue to respire, using up oxygen in the headspace of the package, and at the same time evolve water, increasing the humidity in the headspace. This encourages the growth of spoilage microorganisms leading to damage of the produce tissues. Further, evolved water condenses on packaging leading to the loss of structural integrity (especially in the case of fibreboard) and the requirement for frequent defrost cycles in shipping containers and cool rooms which increases energy requirements and destabilises temperature control. Each produce type has its own optimal gas composition and humidity level for keeping its deterioration to a minimum and with the ever increasing demand from consumers for improved quality, new technologies have developed to keep perishable produce as “fresh” as possible during storage and transport.

One approach has focussed on lowering the level of oxygen in the packaging so as to slow the rate of respiration of the produce. Lowering the levels of oxygen can also provide significant benefits in terms of, for example, reducing and/or inhibiting mould growth.

Another approach has focussed on the use of active packaging. Active packaging employs a packaging material that interacts with the internal gas environment of the package to prevent and/or retard deterioration of the packaged produce, typically by continuously modifying the gas environment by removing gases from or adding gases to the headspace. Active packaging has found particular application in buffering the humidity in the environment within a package. Ideally, the active packaging material should prevent condensation wetting the produce whilst at the same time making sure the produce does not dry out, namely maintaining a high humidity.

EP 443,402 (Kuraray Co. Ltd) describes a laminated packaging material comprising a water-impermeable sheet, an absorbent fibre sheet and a hydrophobic fibre sheet which is permeable to air, for use in heating or insulating foods such as hamburgers and hotdogs.

WO 91/17045 (Commonwealth Scientific and Industrial Research Organisation) describes a packaging material for the packing of, amongst other things, horticultural produce. The packaging material comprises a sheet that is freely permeable to water vapour spaced apart from a sheet which is impermeable to water vapour and liquid water. Within the space there may be included a water-absorbing desiccant in the form of particles or beads.

U.S. Pat. No. 4,977,031 (Temple) describes a material useful for packaging of moisture-sensitive food such as cheese, comprising a support sheet with a bonded water-retentive layer.

GB 2,031,849 (Pfizer Inc.) describes a multi-layered container for storage of particulate hygroscopic substances such as anhydrous citric acid. The container comprises an outer layer having low water-vapour transmission and an inner layer comprising paper, which may optionally be covered by a water-permeable layer.

EP 356,161 (Mitsui Toatsu Chemicals Inc.) describes a film for retaining freshness of vegetables and fruits which comprises a synthetic resin film, a microporous resin film and a water-absorbing layer interposed between the two, said microporous resin film having a maximum pore diameter not larger than 30 microns and a moisture permeability not lower than 100 g/m²/24 hr.

U.S. Pat. No. 4,929,480 (Midkiff et al.) describes an absorbent structure including a perforated upper layer for collecting and retaining exuded fluids from food products such as meat and poultry.

U.S. Pat. No. 5,167,652 (Mueller) describes a thermoplastic film and its use in disposable diapers including an absorbent such as cellulosic fluff or moisture absorbing polymer e.g. ethylene vinyl alcohol copolymer, between a moisture permeable or perforated inner sheet and an outer layer comprising a blend of copolyester and a moisture absorbing copolyamide.

WO 94/03329 (Commonwealth Scientific and Industrial Research Organisation) describes a packaging material comprising a water-impermeable layer and a water-absorbing layer. A sheet which is permeable to water vapour may also be attached to the packaging material.

In spite of significant advances made in the production of packaging materials as described in the prior art, the industry still encounters problems in designing and manufacturing active packaging materials. Typically, the produce to be preserved is of relatively low monetary value. This is especially the case with horticultural produce. Therefore, active packaging material must be cheap in order for its use to be economically viable. In addition, it must be mass producible in order to meet demands. The manufacturer has to balance the aforementioned requirements with the need to ensure the packaging material is made to such a standard that it maintains its functionality. For example, the packaging material needs to maintain its integrity during use, which could be several weeks in transport and/or storage. Balancing all these requirements has proved difficult.

### SUMMARY OF THE INVENTION

In a first aspect, the present invention provides a process for the manufacture of a packaging material, the process comprising
(i) applying a tie layer of molten polyolefin to a water-absorbent layer,
(ii) optionally exposing the product of (i) to pressure,
(iii) applying an outer layer of polyolefin to the tie layer,
(iv) exposing the product of (iii) to pressure, and
(v) allowing the material to cool,
   wherein the tie layer of polyolefin partially impregnates the water-absorbent layer.

Hereinafter, processes involving the steps detailed in the first aspect are referred to as “the tie process” or “the tie processes”.

This process of manufacture has been found to produce a packaging material with much improved mechanical properties, especially in use, when the water-absorbent layer can become laden with water. In particular, the use of a tie layer which partially impregnates the water-absorbent layer has been found to provide excellent bonding properties between the outer polyolefin layer and the water-absorbent layer, whilst not compromising the water-absorbent function of the water-absorbent layer. Furthermore, the process is also highly conducive to scale-up and may be carried out on an industrial scale. In addition, the processes can utilize components which are generally inexpensive. These factors enable considerable cost savings to be made and a relatively cheap packaging material to be produced.

In order to prevent the water-absorbent layer coming into contact with the produce and potentially depositing liquid onto the produce, an inner layer may be provided to the exposed surface of the water-absorbent layer. This inner layer is water vapour-permeable but is substantially impermeable to liquid water.

Thus, in a second aspect, the present invention provides a packaging material comprising
(i) a liquid water- and water vapour-impermeable outer layer,
(ii) a water-absorbent layer,
(iii) a tie layer bonded to the outer layer and the water-absorbent layer, and
(iv) an water vapour-permeable inner layer which is substantially impermeable to liquid water in the water-absorbent layer,
   wherein the tie layer partially impregnates the water-absorbent layer.

Preferably, the water vapour-permeable inner layer is bonded to the water-absorbent layer.

The present inventors have also found that many commercially available adhesives are not suitable for the production of packaging material for storing and/or transporting perishable goods because, as the water-absorbent layer became saturated with water, the strength of the packaging became compromised. Without being limited by theory, it is believed that the reason for this is that many conventional adhesives tend to bond poorly to smooth surfaces such as those presented by plastics such as polyolefins. In addition, although many conventional adhesives tend to bond better to uneven surfaces such as those presented by many of the materials used in water-absorbent layers (e.g. fibrous cellulosic materials), the adhesive qualities of many conventional adhesives are compromised when they come into contact with water. This can result in the breakdown of the bond between the water-absorbent layer and the outer layer when the packaging material is in use and even the leaching of adhesive glue material into the packaging.

Although adhesives are available which adhere to smooth polyolefin-like surfaces, these are often not suitable for use in packaging material as they are potentially toxic. In addition, they can compromise the function of the water-absorbent layer to act as a reservoir for water.

It has now been found that two types of adhesive provide superior packaging material, namely alpha cyanoacrylates and liquid epoxy and amines.

Thus, in a third aspect, the present invention provides a process for the manufacture of a packaging material, the process comprising
(i) applying an adhesive comprising an alpha cyanoacrylate or a liquid epoxy and amine to one or both of
   (a) a surface of a liquid water- and water vapour-impermeable outer layer, and
   (b) a surface of a water-absorbent layer,
(ii) contacting said surfaces, and
(ii) allowing the adhesive to harden.

Hereinafter, processes involving the steps detailed in the third aspect are referred to as “the adhesive process” or “the adhesive processes”.

In a fourth aspect, the present invention provides a packaging material comprising
(i) a liquid water- and water vapour-impermeable outer layer,
(ii) a water-absorbent layer,
(iii) an adhesive layer comprising an alpha cyanoacrylate or a liquid epoxy and amine bonded to the outer layer and the water-absorbent layer, and
(iv) a water vapour-permeable inner layer which is substantially impermeable to liquid water in the water-absorbent layer,
   wherein the water vapour-permeable inner layer is bonded to the water-absorbent layer.

In a fifth aspect, the present invention provides a packaging material produced by the process according to first and third aspects.

The present inventors have also determined that when the water-absorbent layer comprises cellulose fibres, specific densities and thicknesses of this layer provide a superior product.

Accordingly, in a sixth aspect, the present invention provides a packaging material comprising
(i) a liquid water- and water vapour-impermeable outer layer,
(ii) a water-absorbent layer, and
(iii) a water vapour-permeable inner layer which is substantially impermeable to liquid water in the water-absorbent layer,
   wherein the water-absorbent layer comprises cellulose fibres and has a specific weight of from about 15 to about 30 g/m² and a thickness of from about 60 to about 95 microns, and wherein the water vapour permeable inner layer is bonded to the water-absorbent layer.

In a seventh aspect, the present invention provides a method of storing and/or transporting a perishable product, the method comprising inserting the product into, or substantially wrapping the product with packaging material according to any one of the second, fourth, fifth and sixth aspects of the invention.

In an eighth aspect, the present invention provides a method of storing and/or transporting a perishable product, the method comprising the steps of;
(i) inserting the product into an open container lined with packaging material according to any one of the second, fourth, fifth and sixth aspects of the invention,
(ii) placing a sheet of packaging material according to any one of the second, fourth, fifth and sixth aspects of the invention over the product facing the open area of the container, and
(iii) placing a lid on the container.

In a ninth aspect, the present invention provides a method of storing and/or transporting a perishable product, the method comprising the steps of;
(i) inserting the product into an open container lined with packaging material according to any one of the second, fourth, fifth and sixth aspects of the invention, wherein the lining extends beyond the walls of the container,
(ii) placing the lining extensions over the product facing the open area of the container, and
(iii) placing a lid on the container.

In a tenth aspect, the present invention provides a packaging system comprising a container containing a perishable product and packaged according to the invention placed within an enclosure which substantially seals the container from the atmosphere.

Lowering the level of oxygen in the packaging so as to slow the rate of respiration of the produce has been shown to have significant benefits for the transport and/or storage of perishable products.

Accordingly, in an eleventh aspect the present invention provides a method of storing and/or transporting a perishable product according to the invention further comprising placing the container in an environment in which the O₂ content within and/or surrounding the packaging material is regulated.

The present inventors have developed a means for regulating O₂ content which relies, in part, on a pump which is only intermittently activated.

According to a twelfth aspect, the present invention provides a system for controlling an oxygen concentration of an enclosed atmosphere containing respiring produce, the system comprising:

an enclosure to isolate the enclosed atmosphere from an external atmosphere;

an oxygen sensor for sensing the oxygen concentration of the enclosed atmosphere;

a pump for pumping the external atmosphere into the enclosed atmosphere;

a control means for causing the pump to commence operation when an oxygen concentration of the enclosed atmosphere is less than a predetermined minimum concentration, and for causing the pump to cease operation when an oxygen concentration of the enclosed atmosphere exceeds a predetermined maximum concentration; and

means to allow egress of the enclosed atmosphere from the enclosure during operation of the pump.

Due to the presence of respiring produce, an oxygen concentration of the enclosed atmosphere will decrease due to respiration. Thus, upon designation of a desired oxygen concentration range in which the produce is to be stored, the system of the twelfth aspect of the invention provides a means to maintain such an oxygen concentration level. The oxygen concentration level is controlled by balancing the oxygen concentration, the reductive effect of respiration on the oxygen concentration being countered by the increasement effect of pumping the external atmosphere into the enclosed atmosphere.

By providing a pump which is operated only when an oxygen concentration in the enclosed atmosphere falls below a predetermined minimum concentration, embodiments of the twelfth aspect of the present invention provide for operating the pump for only a portion of the time, and thus provide an atmosphere control system with low power requirements. For instance, such a mode of operation of the pump may allow a battery-operated pump, requiring one or more D-cell batteries or the like, to be used in cases where the enclosure contains a pallet of produce requiring storage for a month. Even at low temperatures, such a system may allow a battery-operated pump requiring as few as six D-cell batteries to be used in cases where the enclosure contains a pallet of produce requiring storage for a month. Similarly, such a mode of operation of the pump may allow a battery-operated pump requiring one 12 volt battery or the like, for example a rechargeable battery of at least 12 V, to be used in cases where the enclosure is a larger container such as a shipping container. Pumps having such low power requirements are relatively cheap and, accordingly, the present invention provides a particularly inexpensive method of atmosphere control for an enclosure containing respiring produce. Furthermore, the low power requirements of the system of the present invention, and the low cost of such pumps and power sources, lead to the use of such atmosphere control techniques being commercially viable for storage of smaller quantities of produce, for instance storage of produce on a pallet scale.

According to a thirteenth aspect the present invention provides a method for controlling an oxygen concentration of an enclosed atmosphere containing respiring produce, the method comprising:

isolating the enclosed atmosphere from an external atmosphere;

sensing the oxygen concentration of the enclosed atmosphere;

commencing pumping of the external atmosphere into the enclosed atmosphere when an oxygen concentration of the enclosed atmosphere is less than a predetermined minimum concentration;

ceasing pumping of the external atmosphere into the enclosed atmosphere when an oxygen concentration of the enclosed atmosphere exceeds a predetermined maximum concentration; and

providing means to allow egress of the enclosed atmosphere from the enclosure during said pumping.

In a fourteenth aspect the present invention provides a method of storing and/or transporting a perishable product according to the invention, combined with a system for controlling an oxygen concentration of an enclosed atmosphere containing respiring produce of the invention.

As will be apparent, preferred features and characteristics of one aspect of the invention are applicable to many other aspects of the invention.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps. The invention is hereinafter described by way of the following non-limiting Examples and with reference to the accompanying figures.

### BRIEF DESCRIPTION OF THE ACCOMPANYING DRAWINGS

FIG. 1. Cellulose partially impregnated with polyethylene after co-extrusion or mono-extrusion.

FIG. 2. Examples of quality scores for curd blackening in cauliflower: (A) Quality score of 1: florets are white with no visually apparent discolouration (top left); (B) Quality score of 3: minor curd blackening evident with small brown spots visible on some florets (<5% surface area affected) (top right); (C) Quality score of 5: highly apparent black spots on florets of larger size and intensified colour (10-20% surface area affected) (bottom left); (D) Quality score of 7: severe blackening of florets with localised cellular breakdown (>30% surface area affected) (bottom right).

FIG. 3. Influence of temperature and time on the development of curd blackening of cauliflower stored continually at 20° ▪. (E) or stored at 3° C. from 11 days prior to being transferred at 20° C. (□).

FIG. 4. Time course of moisture loss (±se) from cauliflowers stored at 3° C. in waxed boxes, standard fibreboard boxes and prototype 1 (referred to in the Figure as “CSIRO's MCT Liner”) lined boxes. Boxes were transferred to 25° C. on day 22.

FIG. 5. Quality index of cauliflowers (±se) stored for 21 days at 3° C. in waxed boxes, standard fibreboard boxes and prototype I (referred to in the Figure as “CSIRO's MCT Liner”) lined boxes. Boxes were transferred to 25° C. on day 22.

FIG. 6. Influence of liner and wrapping on the percentage of weight loss from curds stored at 3° C. for 28 days (“MCT liner” refers to prototype 2-liner).

FIG. 7. Mean consumer purchase desire of cauliflowers after 36 days of storage under modified atmospheres of varying O₂ and CO₂ concentrations (open bars) followed by storage under point of sale conditions, 25° C. and 21% O₂ (checked bars). Data are means (n=3) with standard errors.

FIG. 8. Influence of reduced CO₂ (lime scrubbed—low CO₂) and high CO₂ (no scrubbing) on the O₂ consumption rate of cauliflowers stored at 3° C.

FIG. 9. Illustrates a system for controlling an oxygen concentration of an enclosed atmosphere containing respiring produce.

FIG. 10. Illustrates the oxygen concentration control achieved by the system of FIG. 9.

FIG. 11. Oxygen concentration in the atmosphere contained within the tented pallet.

FIG. 12. Oxygen concentration within the head space of standard fibreboard boxes (plain) or prototype 2 (referred to as MCT) lined boxes both stored within a tented pallet. ‘Top’, ‘Mid’ and ‘bot’ refer to the top, middle and bottom layers of the three layer pallet. Prototype 2 lined boxes in the first trial had the MCT liner on both the base and the outer sleeve. Prototype 2 lined boxes in the second trial had the base lined with a loose fitting sheet of prototype 2 liner on the top of the produce. Data are means (n=3) with standard errors.

FIG. 13. Moisture loss (%) from cauliflowers stored in prototype 2 (referred to as MCT) lined boxes or standard fibreboard (Plain) boxes which were either stored within a tented pallet or outside the tent in the cool room. Data are for the second combined experiment and prototype 2 lined boxes had the base lined with a loose fitting sheet of prototype 2 liner on the top of the produce. Data are means (n=3) with standard errors.

FIG. 14. Mean initial and final quality index data of cauliflowers stored for 26 days at 3° C. either inside a tented pallet at 2% O₂ or outside the tent at 21% O₂. Cauliflowers were stored in either plain fibreboard cartons or prototype 2 (referred to as MCT) lined cartons (base lined with a loose-fitting sheet of liner over the top of the produce). Data are means (n=3) with standard errors.

FIG. 15. Circuit diagram for a controller for the system of FIG. 9.

### DETAILED DESCRIPTION OF THE INVENTION

Outer Layer

The outer layer of the packaging material is liquid water- and water vapour-impermeable. It acts as a barrier to water loss from the enclosed environment and also as a potential surface for condensation of water vapour which would otherwise escape. In one embodiment, the outer layer has a permeability to water vapour of less than 4 g/m²/day (American Society of Testing Materials—Method E96 at 24° C. and 50% RH).

Suitably, the outer layer is made from a material which is flexible, non-toxic, light-weight and cheap. Except for packaging materials made using the tie process, the outer layer can be made from any suitable petrochemical- or plant-derived organocarbon. Preferably, the outer layer comprises a polyolefin such as, for example, polyethylene, polyvinylchloride, polypropylene or any mixture thereof.

Where the packaging material is made using the tie process, the outer layer comprises a polyolefin such as, for example, polyethylene, polyvinylchloride, polypropylene or any mixture thereof.

Suitably, the outer layer is from about 10 to about 50, preferably from about 10 to about 40, more preferably from about 15 to about 30 and yet more preferably from about 15 to about 25 μm thick.

Tie Layer

The tie layer acts as a bonding layer between the outer layer and water-absorbent layer. Suitably the water-absorbent and outer layers, independently, contact at least 90%, preferably at least 95%, and more preferably at least 98% of the respective surface area of the tie layer. The tie layer must be capable of ensuring adequate bond strength without deleteriously effecting the function of the outer and water-absorbent layers. The tie layer will preferably be incorporated into the packaging material using either the tie process of the present invention or a process akin thereto. Typically, the tie layer material will be softened prior to application to the water-absorbent layer and subsequent addition of the outer layer. Therefore, the material from which the tie layer is made must lend itself to such a process and application.

Suitably, the tie layer is made from a material which is flexible, non-toxic, light-weight and cheap. Except for packaging materials made using the tie process, the tie layer can be made from any suitable petrochemical- or plant-derived organocarbon. Preferably, the tie layer comprises a polyolefin such as, for example, polyethylene (PE), polyvinylchloride (PVC), polypropylene (PPE) or any mixture thereof.

The tie layer partially impregnates the water-absorbent layer. This means that the tie layer must extend beyond the surface of the water-absorbent layer and penetrate the matrix or pores below the surface. Typically this is achieved by applying the tie layer as a molten material and, preferably, applying pressure before the tie layer hardens so that the tie layer penetrates the water-absorbent layer.

Preferably, the tie layer is thinner than the outer layer. Suitably, the tie layer is from about 3 to about 20, preferably from about 5 to about 15 and more preferably from about 5 to about 10 μm thick.

The tie layer may have the same or a different composition from the outer layer. In a preferred embodiment, the compositions are the same, especially where the tie process is used.

In a preferred embodiment, the outer and tie layers are composed of polyolefins. Depending on the particular polyolefins or mixtures of polyolefins used, layers with greater or lesser flexibility will be obtained. In addition, polyolefins may be chosen with suitable viscosity properties (as measured through the melt-flow index (MFI)) if this feature is important in the process of manufacture as discussed later. Suitably, the polyolefins will have a MFI of from about 2 to about 20, preferably from about 2 to about 10, more preferably from about 2 to about 5, yet more preferably from about 2 to about 3 and even more preferably from about 2.2 to about 2.6.

A particularly preferred polyolefin is polyethylene. Preferred polyethylenes include linear low density polyethylene (LLDPE) and low density polyethylene (LDPE). LLDPE is available with a melt-flow index (MFI) of from 2 to 10 and a density of from 920 to 940 kg/m³. A preferred LLDPE has a MFI of from 2 to 3, for example 2.5, and a density of from 930 to 940 kg/m³, for example 935 kg/m³. LDPE is available with a MFI of 2 to 10 and a density of from 920 to 925 kg/m³. A preferred LDPE has a MFI of 2 to 2.5, for example 2.3, and a density of 921 kg/m³.

The ratio of LLDPE and LDPE can be varied from 0:100 to 100:0. The greater the proportion of LDPE, the softer (more flexible) the plastic is as a solid and the lower the viscosity is as a liquid.

It is also possible to mix polyolefins. For example, it may be advantageous to mix a polyethylene with a polypropylene for the tie layer to increase the viscosity of the tie layer.

The outer and/or tie layers may further comprise one or more additives such as colouring agents, adhesives and surface modification agents such as, for example, slip, anti-static and anti-blocking agents.

Suitable colouring agents can be prepared as a master batch of LDPE and TiO₂ in a ratio of 1:1. This mix provides a white background against which pigments, especially organic pigments, may be added. For a white or coloured layer, the master batch may be added in an amount of up to 10 wt % of the total outer layer or total tie layer composition. Colouring agents are largely aesthetic and this may be an advantage for a horticultural packaging.

Surface slip agents may be included to reduce the problem of friction limiting the application of the material and thus facilitating high speed packaging material manufacture. Suitable surface slip agents include, for example, oleamide and erucamide.

Adhesive Layer

Instead of using a tie layer, the present inventors have found that certain more conventional adhesives function well to bond the water-absorbent and outer layers together.

Suitable adhesives are those which bond to cellulosic fibres and polyolefins, for example, polyethylene. Suitable adhesives include, for example, alpha cyanoacrylates, such as super glue gels (e.g. Ibex™ Super Glue Gel), and epoxy resins such as two-part liquid epoxy/amine adhesives. Examples of the latter include araldite (e.g. Selleys Araldite ex. Selleys Pty Ltd, Padstow, N.S.W.) containing, as Part A, a liquid epoxy resin (bisphenol A-epichlorhydrin reaction product (NAMW<700)), and, as Part B, an epoxy hardener containing 80 ml/l tertiary amine (dimethylaminopropyl-1,3-propylene diamine 1<10%, 2,4,6-tri(dimethylamino-methyl)phenol 1<10%).

Water-Absorbent Layer

The water-absorbent layer may be any suitable material that is capable of absorbing water. Ideally, the material should have good moisture uptake, holding and transmissivity (ie. wicking) properties.

The water-absorbent material acts as a reservoir for water, taking up water through contact with water vapour which condenses on the outer or tie layer. The distribution of water vapour within a package of horticultural produce in which there are gradients of temperature is limited by the rate of diffusion of water vapour. The diffusion limitation results from the relatively small differences of partial pressure for water vapour for a given difference in relative humidity. Accordingly, due to this diffusion limitation it is desirable that the water-absorbing material is as close as possible to the horticultural produce.

It is important that the water-absorbent layer still be able to absorb liquid water even after equilibration in high relative humidity environments. This is because the relative humidity inside sealed packages of horticultural produce is typically, and preferably so as not to dry out the produce, above 95%, e.g. 98%. Consequently, the water-absorbent layer must still be able to function as a liquid water reservoir even in these high humidity conditions. Furthermore, it should be noted that in many instances the function of the water-absorbent layer is to assist in keeping the relative humidity inside the packages at optimal levels, and not necessarily to act as a reservoir for all water which evaporates from the perishable product.

The water-absorbent layer is preferably capable of absorbing at least 10% of its weight in water from liquid water after being equilibrated with an atmosphere saturated with water vapour.

Suitably, the water-absorbent layer is able to absorb at least 40, preferably at least 50 and more preferably at least 60 g of water per m².

The water-absorbent layer may comprise polymers capable of absorbing liquid water or water vapour. Such polymers tend to swell on absorption of liquid water. Suitable water-absorbing polymers include starch-polyacrylonitrile copolymers (as described in JP 43395/1974), cross-linked polyalkylene oxides (as described in JP 39672/1976), saponified vinyl ester-ethylenically unsaturated carboxylic acid copolymers (as described JP 13495/1978), self-cross-linking polyacrylates obtained by a reversed-phase suspension polymerization process (as described in JP 30710/1979), the reaction products of a polyvinyl alcohol type polymer and a cyclic anhydride (as described in JP 20093/1979), and cross-linked polyacrylates (as described in JP 84305/1980). Preferred polymeric materials include polyvinyl alcohols. For example a suitable water-absorbent layer may be a commercial film of polyvinyl alcohol that is insoluble in cold water but soluble in water above 80° C. (Poval Type L, ex Kuraray).

The amount of a water-absorbing polymer to be used differs depending on the kind and quantity of vegetables or fruits, the packaged condition, the state of preservation, etc., but usually it is in the range of from 0.001 to 1 and preferably from 0.005 to 0.5% based on the weight of vegetables or fruits.

Water-absorbent polymers are preferably provided in the form of a film in which the polymer is present in the range of from 1 to 100 g/m² of the film.

In a particularly preferred embodiment, the water-absorbent layer comprises cellulose. Suitable cellulose material can be derived from soft, hardwood or semi-hard wood sources. A preferred source is a softwood such as, for example, pine. It is also preferred that the cellulose material be derived from a source which has been mechanically processed (pulped) rather than chemically processed. The cellulosic material may comprise up to 100% softwood pulp fibres. Alternatively, the cellulosic material may comprise softwood pulp and up to about 33% hardwood fibre. Softwood fibres typically have fibre diameters of from about 35 to about 45 μm and lengths of from about 2 to about 5 mm. Hardwood fibres typically have fibre diameters of from about 14 to about 32 μm and lengths of from about 1 to about 2 mm. The cellulosic material may further comprise synthetic fibres such as melt-blown polyethylene or polypropylene, which may improve the handling properties. In a preferred embodiment, the water-absorbent layer does not comprise super-absorbent materials such as carboxymethylcellulose (CMC).

Preferably the water-absorbent layer is a paper material comprising cellulose fibres. Examples of suitable paper materials are those which have low levels of compression such as, for example, the PCB, BRL, EGF and BETA2 toilet tissue papers (ex. Kimberley-Clark Australia Pty Ltd). Suitably the papers have a specific weight (mass per unit area) in the range from about 10 to about 40, preferably about 10 to about 35 and more preferably about 15 to about 30 g/m². Suitable papers may also have a high level of “crepe”, having a ratio of actual surface area to projected area of from about 1.3 to about 1.6, for example about 1.4.

The water-absorbent layer suitably has a thickness of from about 40 to about 110, preferably from about 50 to about 100 and more preferably from about 60 to about 95 μm.

The water-absorbent layer suitably has a machine direction tensile strength of from about 15N/75 mm to about 35N/75 mm.

Examples of other suitable paper materials include facial tissues, for example Kleenex™ Executive Collection ex. Kimberley-Clark Australia Pty Ltd, lens tissues, for example Kimwipes™ delicate task wipers ex. Kimberley-Clark Australia Pty Ltd, hand towels, for example Deluxe Soft interleaved towels ex. Kimberley-Clark Australia Pty Ltd, paper towelling, for example Kimdri™ roll towel ex. Kimberley-Clark Australia Pty Ltd, filter papers, for example No. 42 Ashless (0.01%) filter paper ex. Whatman International Ltd., and Butchers papers, for example ex. Australian Paper Mills Company Pty Ltd, Victoria, Australia.

In a preferred embodiment, the water-absorbent layer comprises cellulosic fibres and has a specific weight (mass per unit area) of from about 10 to about 40, preferably from about 15 to about 30 g/m², and a thickness of from about 40 to about 110, preferably from about 60 to about 95 microns.

Water Vapour-Permeable Inner Layer

The inner layer must be water vapour-permeable but substantially impermeable to liquid water in the water-absorbent layer. This is to prevent water present in the water-absorbent layer coming into direct contact with the surface of the packaging produce, ie. the inner layer should “seal” liquid moisture away. Although some configurations of the packaging of the present invention may enable liquid water from the water absorbent layer to penetrate the water vapour-permeable layer, such pressure is typically not exerted in the packaging of perishable products such as horticultural produce.

In some circumstances the water vapour-permeable inner layer may allow liquid water to cross from the surface facing the perishable product to the water-absorbent layer, however, it is preferred that the water vapour-permeable inner layer is substantially impermeable to the flow of liquid water from both surfaces.

The inner layer can be composed of a number of hydrophobic or hydrophilic polymers such as the polyenes, polyvinyl chloride and fluorinated polymers. The physical state of the polymer should be such that it is freely or partly permeable to water vapour. In a preferred embodiment, the inner sheet is composed of a woven hydrophobic polyolefin, such that while it is freely permeable to water vapour, it offers resistance to the passage of liquid water from the water-absorbent layer back into the inside of the packaging. Materials that meet these specifications includes the non-woven fabrics made of polyethylene, such as Tyvek™ made by Dupont, non-woven fabrics of polypropylene such as Evolution™ and Evolution II™ made by Kimberley-Clark, or perforated films of these polymers, or papers or woven fabrics made from cotton or similar fibres, that have been treated to render their surface hydrophobic. The production of such materials is known in the art, for example see GB 1,453,447.

Preferably, the water vapour-permeable inner layer comprises spun-bond polypropylene of about 16 to about 20 g/m². The inner layer preferably has a density of at least 16 g/m² and can withstand a hydrostatic pressure of at least 10 mm H₂O. The degree of impermeability to water of this layer can be readily measured according to methods known in the art.

The inner layer is preferably bonded to the water-absorbent layer. Preferably, the bonding is over less than 5%, more preferably over less than 3%, of the surface area of the inner layer. Any suitable mean of adhesion may be used. A preferred means of bonding is by a heat-melt glue such as, for example, ethylene vinyl acetate and hydrocarbon resin (ex Bostik).

Supporting Layer

The packaging material may further include an external supporting layer. Typically, the supporting layer is bonded in some manner to the outer layer, however, the packaging material of the invention may be in the form a bag placed inside a suitable container, wherein the walls of the container can be considered as the supporting layer(s). The function of the supporting layer is to provide mechanical strength to the packaging material and may be composed of a number of such materials well known in the field such as a corrugated paper carton.

Process of Manufacture

For the avoidance of doubt, the features and embodiments of the outer, tie, adhesive, water-absorbent and inner layers of the packaging material described above are equally applicable to the tie and adhesive processes described below.

The Tie Process

The tie process involves applying the tie layer of molten polyolefin to the water-absorbent layer, applying the outer layer of polyolefin to the tie layer, exposing the resulting product to pressure and allowing the packaging material to cool.

Preferably, the tie layer is applied to the water-absorbent layer by an extrusion process. In the extrusion process, the tie layer is applied as a coating of molten polymer web. The outer layer may also be applied simultaneously by an extrusion process, that is, a co-extrusion process.

Once the tie and outer layers have been applied, the material comprising the water-absorbent, tie and outer layers is exposed to pressure. The pressure ensures the layers bond together and facilitates the impregnation of the tie layer into the water-absorbent layer. Suitably, the pressure applied is in the range from about 275 to about 1400, preferably from about 350 to about 1000, more preferably from about 400 to about 800 and yet more preferably from about 480 to about −700 kPa, for example about 550 kPa.

A preferred means of applying pressure is to pass the material through a nip point. A suitable nip point may be that generated by two rollers spaced in close proximity to each other.

The tie layer is in a molten state when applied in the tie process. The outer layer is also preferably in a molten state when applied to the tie layer. This molten state is suitably achieved by raising the temperature of the polyolefin material to from about 150 to about 350, preferably from about 200 to about 300 and more preferably from about 225 to about 275° C., for example, about 250° C. Heating the tie layer and optionally the outer layer is also conducive to applying the layer(s) as extrusion coatings in an extrusion process.

The material may optionally be cooled at the point or area of applying pressure. For example, chilled rollers may be used at a nip point. Suitably, the material may be cooled to a temperature below 100° C., preferably below 75° C. and more preferably below 50° C., for example to 45° C., at the point or area of applying pressure.

After the material has been exposed to pressure, the material may be cooled by passing it over one or more rollers, which may optionally be chilled.

Optionally, an additional pressure step may be included before the application of the outer layer to facilitate impregnation of the tie layer into the water-absorbent layer. If such an additional process step is employed, the two-layer construct my be cooled at the point or area of compression. Suitable means for compression and cooling are as described above in relation to the material to which the outer layer has been applied. When an additional pressure step is included, it is preferable to add the outer layer as a molten polyolefin, especially when cooling is employed in the additional pressure step, to facilitate good bonding of the outer layer to the tie layer.

The tie process as described herein may be conducted at a lineal web speed of between about 50 and about 300 m/min, preferably between about 150 to about 250 m/min.

Suitable equipment for the manufacture of packaging material using the tie process will be apparent to the skilled person.

The Adhesive Process

The adhesive process involves applying an adhesive to one or both of the liquid water- and water vapour-impermeable layer and the surface of a water-absorbent layer, contacting the surfaces and allowing the adhesive to harden.

The adhesive may be applied by any suitable means such a spraying or contact, e.g. rolling. Preferably, the adhesive is applied over substantially the whole (e.g. at least 90%, preferably at least 95%) of at least one of the surfaces to be bonded. Where the adhesive is applied to both surfaces, then the adhesive is preferably also applied over substantially the whole (e.g. at least 90%, preferably at least 95%) of the second surface.

In the case of liquid epoxy and amine adhesives, the epoxy resin may be applied to one surface and the epoxy hardener to the other. Optionally, the packaging material may be exposed to pressure in order to facilitate good bonding of the surfaces and an even distribution of adhesive between the layers.

Packaging and Perishable Products

The packaging material of the present invention may be used to inhibit or retard the deterioration of any perishable product during storage and/or transport. However, the packaging materials and systems have been found to be particularly advantageous as preserving horticultural produce such as fruit, vegetables and flowers. Examples of such produce include: brassicas (e.g. cauliflower and broccoli), leafy vegetables (e.g. lettuce, celery, bok choy and silver beet), root vegetables (e.g. carrot, parsnip, radish), fruit (e.g. citrus, table grape, tomato, mango, rambutan, lychee, stone and pome fruit) and all cut flowers (e.g. native or exotic species). The packaging materials may also be used to wrap perishable products other than horticultural produce such as meat, poultry, fish and cheese.

As is routine in harvesting perishable goods, the produce is preferably cooled after harvesting or preparing. This may be done prior, during or after packaging.

Some perishable products, such as tropical fruits, comprise large amounts of moisture. In these circumstances, it may be desirable to ensure that at least some water is able to escape from the packaging which guards against excessive water build up in the water absorbent layer and/or on the fruit. In one embodiment the produce, for instance tropical fruit, is packaged such that the packaging material does not completely seal in the air. An example of how this can be achieved is by use of the method of the eighth aspect, where placing a sheet of packaging material over the produce facing the open area of the container clearly does not seal the air within the container. In another embodiment, the liquid water- and water vapour-impermeable outer layer can have numerous small holes which allow some water to escape. In these circumstances, the skilled addressee can readily determine a suitable degree of which water (preferably water vapour) is able to escape for a particular perishable product to suitably stored and/or transported.

As used herein, the term “substantially wrapping the product” means most, if not all, of the perishable product is surrounded by the packaging material. As noted above, the methods of packaging of the invention do not necessarily completely exclude the flux of air between the inside and outside of the packaged material. However, this flow is nonetheless typically by diffusion rather than mass flow. The length of the diffusion pathway is typically set by the amount of overlap between the layers as described in the seventh, eighth and ninth aspects of the invention and is dependent on the type of produce and the application. Ideally the length of the diffusion pathway and the resistance it offers is sufficient to minimise the loss of water vapour while enabling the sufficient flux of O₂ into the package and CO₂ out of the package. This process is aided by the fact that water diffuses at a substantially lower rate than, for example, carbon dioxide. Furthermore, as used herein the term “substantially seals the container from the atmosphere” is defined in a similar manner.

Bioactive Molecules

The water absorbent layer may comprise bioactive molecules, or precursors thereof where the bioactive molecule is released upon exposure to water. Preferably, the bioactive molecule is volatile and able, to penetrate the water vapour-permeable inner layer.

In one embodiment, the bioactive molecule is used to limit the group and/or reproduction of a microorganism such as fungus, bacteria and moulds. An example of such as molecule is SO₂ which is provided as a precursor, for example metabisulphite, and released from the water-absorbent layer upon exposure to water.

In another embodiment, the bioactive molecule is able to regulate plant hormone action such as that of ethylene. An example of a bioactive molecule that can be used in the packaging material of the present invention which blocks the action of ethylene is 1-methylcyclopropene.

Other bioactive molecules, or precursors thereof where the bioactive molecule is released upon exposure to water, for use in the packaging material of the present invention will readily be known to those skilled in the art.

Control of Oxygen Content

When transporting and/or storing perishable products using the packaging materials, and methods of use thereof, of the present invention, the quality of the produce can be further enhanced by incorporating means of regulating O₂ content. Oxygen content can be regulated by any means known in the art, however, it is preferred that this is achieved using a system comprising:

an enclosure to isolate the enclosed atmosphere from an external atmosphere;

an oxygen sensor for sensing the oxygen concentration of the enclosed atmosphere;

a pump for pumping the external atmosphere into the enclosed atmosphere;

a control means for causing the pump to commence operation when an oxygen concentration of the enclosed atmosphere is less than a predetermined minimum concentration, and for causing the pump to cease operation when an oxygen concentration of the enclosed atmosphere exceeds a predetermined maximum concentration; and

means to allow egress of the enclosed atmosphere from the enclosure during operation of the pump.

The means to allow egress of the enclosed atmosphere from the enclosure during operation of the pump preferably comprises a flow path, the flow path being configured to allow mass flow of the enclosed atmosphere out of the enclosure, while limiting diffusion between the external atmosphere and the enclosed atmosphere. Such embodiments provide a passive means to allow egress of the enclosed atmosphere from the enclosure during operation of the pump, without requiring moving parts such as valves, and without requiring power-operated parts. Removing the need for moving parts provides for a more robust system, which is particularly advantageous where the storage system is for storage during transportation of respiring produce.

In embodiments comprising a flow path, the flow path is preferably configured such that diffusion between the external atmosphere and the enclosed atmosphere is limited to a rate less than a rate of respiration of the respiring produce in the enclosed atmosphere, such that diffusion into the enclosed atmosphere does not cause a rise in oxygen concentration of the enclosed atmosphere. Indeed, such diffusion further reduces the time for which the pump is required to be operated and thus further reduces the power requirements of the system. In such embodiments, the means to allow egress of the enclosed atmosphere from the enclosure during operation of the pump may comprise a venting tube, wherein a bore of the venting tube provides the flow path. Preferably a length of the venting tube is significantly greater than a diameter or cross-sectional dimension of the venting tube so as to limit diffusion between the external atmosphere and the enclosed atmosphere. Suitably the lengths and diameters of venting tubes vary depending on the nature and amount of the respiring produce being stored. For example, an enclosure containing a pallet-load of respiring produce may have a venting tube of not less than about 30 centimetres in length and no more than about 4 millimetres in diameter or cross sectional dimension. However, where the enclosure contains a pallet-load of high respiring produce such as cauliflower or broccoli, higher diffusion rates may be acceptable without causing a rise in oxygen concentrations, such that a shorter flow path may be provided. For example, the venting tube may be about 15 centimetres long and about 4 mm in diameter in some such cases. High respiring produce refers to produce having a high respiration rate.

In alternate embodiments, the means to allow egress of the enclosed atmosphere from the enclosure during operation of the pump may comprise a plurality of baffles, the flow path being provided by an aperture in each baffle. Preferably, the baffles are placed in substantially parallel alignment at small spacings for purposes of compactness. Preferably, an aperture of each baffle is distal from an aperture of each adjacent baffle in order to increase an effective length of the flow path, thus increasing a diffusion path length between the enclosed atmosphere and the external atmosphere. Again the diffusion path length may be determined based on a respiration rate of produce within the enclosed atmosphere, such that diffusion into the enclosed atmosphere is sufficiently limited to prevent an undesirable rise in oxygen concentration.

In preferred embodiments of the invention, the oxygen sensor senses the oxygen concentration of the enclosed atmosphere substantially continuously. Such embodiments provide a system with substantially immediate response to the oxygen concentration falling below the predetermined minimum concentration level or rising above the predetermined maximum concentration level, thus allowing the oxygen concentration to be maintained more closely to a desired level.

The oxygen sensor preferably provides an output voltage which is representative of oxygen concentration. Preferably, the oxygen sensor is a galvanic cell-type sensor operable in the absence of a separate power source. As such sensors do not impose additional power requirements on a power supply of the system, galvanic cell-type sensors are particularly suitable in the system of the present invention. Furthermore, galvanic cell-type oxygen sensors operate continuously and thus provide a substantially continuous indication of oxygen concentration, limited only by the electrochemical response time characteristics of the galvanic cell. Such a continuous indication of oxygen concentration provides for a system with a substantially immediate response to the oxygen concentration falling below the predetermined minimum concentration level or rising above the predetermined maximum concentration level, thus allowing the oxygen concentration to be more closely maintained at a desired level. The oxygen sensor may be a KE-25 sensor produced by Figaro USA, Inc, of 3703 West Lake Ave, Suite 203, Glenview, Ill., 60025, United States of America, which provides oxygen concentration measurements from 0% to 100% concentration to an accuracy of within 1%, and incorporates a thermistor for temperature compensation, allowing for use of such a sensor in varying temperature conditions.

The enclosure may be made from any suitable material. For example it may be made from a plastic material such as polyethylene to form a polyethylene bag. Preferably, the polyethylene bag has an opening large enough to enable respiring produce, typically held within a container such as a carton or box, to be stacked into the bag while on a pallet, such that sides of the bag may be drawn up around the stacked produce and the opening sealed in order to form the enclosure. Alternatively, the enclosure could be a conventional freight container used to transport produce by road, rail, air or sea. Such containers are typically metal.

In embodiments in which the enclosed atmosphere comprises a container-load of respiring produce, the system preferably further comprises a rechargeable power supply operable to be recharged from the container power supply when the container is powered, and operable to power the pump and control means when the container is not powered. The rechargeable power supply may comprise a rechargeable battery of at least about 12 V.

The present invention also provides a method for controlling an oxygen concentration of an enclosed atmosphere containing respiring produce, the method comprising:

isolating the enclosed atmosphere from an external atmosphere;

sensing the oxygen concentration of the enclosed atmosphere;

commencing pumping of the external atmosphere into the enclosed atmosphere when an oxygen concentration of the enclosed atmosphere is less than a predetermined minimum concentration;

ceasing pumping of the external atmosphere into the enclosed atmosphere when an oxygen concentration of the enclosed atmosphere exceeds a predetermined maximum concentration; and

providing means to allow egress of the enclosed atmosphere from the enclosure during said pumping.

In preferred embodiments, the step of sensing is performed substantially continuously.

The step of isolating the enclosed atmosphere containing respiring produce from an external atmosphere may comprise placing a polyethylene bag or the like on a pallet, stacking the respiring produce into the bag on the pallet, drawing sides of the bag around the stacked respiring produce, and sealing the bag. The step of stacking the respiring produce may comprise forming a central void within the stacked produce, in order to facilitate even atmospheric conditions throughout the enclosed atmosphere.

In embodiments in which the enclosed atmosphere comprises a container-load of respiring produce, the method preferably further comprises providing a rechargeable power source operable to be recharged from the container power supply when the container is externally powered, and operable to power the pump and control means when the container is not externally powered.

The step of sensing the oxygen concentration may be performed by providing a galvanic cell-type oxygen sensor, and carrying out the steps of commencing and ceasing by reference to an output voltage of the sensor.

The step of providing means to allow egress of the enclosed atmosphere from the enclosure preferably comprises providing a flow path which permits mass flow from the enclosed atmosphere to the external atmosphere, while limiting diffusion between the enclosed atmosphere and the external atmosphere. The flow path may be provided by way of a venting tube, or by way of a plurality of baffles each having an aperture.

### EXAMPLES

### Example 1

### Water Absorption Characteristics of Various Papers

Six types of paper, potentially useful as the water-absorbent layer, were assessed for their capacity to absorb moisture on a mass and area basis. Each paper type was pre-weighed and separately placed between a layer of polyethylene and ‘evolution fabric’ (Kimberley Clark). Four replicates samples of each of the six paper types were then adhered to the underside of lids of 3.5 L plastic containers filled with approximately 1 cm of warm (initial temperature 40° C.) deionised water. The containers were then stored at 3.5° C. for 16 hours. Each paper type was reweighed at the end of the experiment and the results are presented in Table 1.

TABLE 1
Water absorption capacity of six paper types.

| | Initial | Final | | % weight | |
|---|---|---|---|---|---|
| Paper type | weight | weight | Difference | gain | g/cm |
| Filter paper | 0.2232 | 0.2330 | −0.0002 | 0 | 0.0000 |
| Kleenex tissue | 0.1419 | 0.2133 | 0.0714 | 50 | 0.0029 |
| Hand towel | 0.1088 | 0.1653 | 0.0565 | 52 | 0.0023 |
| Butchers paper | 0.1263 | 0.2430 | 0.1167 | 92 | 0.0047 |
| Paper towelling | 0.0986 | 0.2203 | 0.1217 | 123 | 0.0049 |
| Lens tissue | 0.0561 | 0.0724 | 0.0163 | 129 | 0.0029 |

The papers were also assessed for their transmissivity to water (i.e. their potential to act as a wick). Ten replicate strips (dimensions 20×1.5 cm) of each of the toilet paper, facial tissue and paper towelling were positioned adjacent to small containers each having 15 ml of dye-coloured water, such that only 1 cm of each strip was in contact with the water. The time taken for the coloured water to travel from the point of contact to the end of the paper strip was recorded. The area of the strip, divided by the length of time, equalled the velocity at which the water travelled through the paper.

The velocity at which the water travelled through the toilet paper and facial tissue was about three times faster than for the paper towelling. Furthermore, water uptake by Butchers paper, a moderately processed paper was 50% less than moisture uptake by toilet tissue, a minimally processed paper. In general, the papers made from the least processed fibre had the best moisture uptake, water holding capacity and transmissivity.

Toilet tissue was selected for further investigation. It is readily available in a vast range of thicknesses and grades, and it is relatively cheap. PCB, BRL, EGF and BETA2 toilet tissue papers (Kimberley Clark), have the technical specifications shown in Table 2.

### Example 2

### Construction of Packaging Material

Prototype 1: Prototype 1 was handmade as a composite of three layers:

Layer 1—a liquid water and water vapour-impermeable outer layer consisting of a low density, white polyethylene sheeting of 50 μm thickness;

Layer 2—a water-absorbent layer consisting of 1-ply bathroom tissue paper having a density of 16.5 g/m² and thickness of 80 μm (ex Kimberley Clark: WSP); and

Layer 3—a water vapour-permeable inner layer consisting of spun bond polypropylene having a density of either 18 or 20 g/m² (ex Kimberley Clark: Evolution Fabric).

Layers 1 and 2 were glued together through bonding with a web-pattern (150×150 mm) of heat-melt glue (Bostik). Layer 3 was then bonded to bonded layers 1-2 either with a web pattern with heat-melt glue, or in the corners and margins of the sheets when the prototype 1 was used as bag.

Prototype 2: Prototype 2 was manufactured in a two-step process. Layer 1 was a polyethylene of 20 μm thickness, which is thick enough to be essentially impermeable to water in liquid or vapour form. Four different cellulose-based materials (papers) were used as the water-absorbent layer as detailed in Table 2. In a first step, the water-absorbent layer was bonded to layer 1 using a polyethylene based tie layer (layer 2, 10 μm). The layer 2 material formed a bond with the cellulosic material and was compatible for bonding with the layer 1 material. In a second step, the laminates from the first step and a layer of spun-bond polypropylene (Evolution fabric) were bonded with heat-melt glue in the corners and margins of the sheets to form a sheet that could be arranged into a bag configuration.

In prototype 2, layers 1 and 2 and the paper were bonded simultaneously using an extrusion lamination process as follows. The paper layer was introduced into the polyethylene extrusion mill as a continuous sheet under tension, while the polyethylene of layers 1 and 2 were extruded in molten form under pressure and at high temperature. The molten polyethylene (250° C.) of layer 2 was first contacted with the paper on one side and then with the molten polyethylene of layer 1. All three materials were drawn through a high pressure nip point (550 kPa, 45° C.) at which the polyethylene layers condense to a solid to form the three layered laminate which is thereafter cooled to ambient temperature as it is passed over a series of rollers and finally wound onto a reel. The process occurred at a lineal speed of 150 to 250 m/min.

TABLE 2
Technical specifications of four paper types.

| | | EGF | PCB | BETA2 | BRL |
|---|---|---|---|---|---|
| Density (g/m2) | | 19.5 | 20.0 | 18.2 | 26.0 |
| Thickness (bulk) (μm) | | 70.0 | 70.0 | 64.0 | 90.0 |
| MD Tensile (N/75 mm) | | 20.0 | 16.0 | 20.0 | 30.0 |
| CD Tensile (N/75 mm) | | 10.0 | 7.0 | 10.0 | 16.0 |
| Wet CD (N/75 mm) | | — | — | — | 3.0 |
| Stretch MD | | 20% | 15% | 20% | 30% |
| Composition | bisulphite | 52% | 60% | 65% | 60% |
| | treated pine | unbleached | unbleached | unbleached | unbleached |
| | * thermo- | 32% | 30% | 30% | 30% |
| | mechanical- | unbleached | bleached | bleached | bleached |
| | treated pulp | | | | |
| | ** converted | 16% | 10% | 5% | 10% |
| | waste product | | | | |

* Thermo mechanical pulp is a more ‘crude’ form of fibre it results in a strong, tough and abrasive fibre compared to bisulphite-treated pine. Average fibre length for thermo mechanical pulp is 2.8 to 3 mm and 2.2 to 2.3 mm for bisulphite treated pine.
** Converted waste product refers to product of similar composition which is recycled back into the production system.

The bonding of the spun-bond polypropylene layer to the laminate was performed as follows. The laminate and the polypropylene layer were wound from separate spindles such that the polypropylene was proximal to the water-absorbent layer. The laminate and the polypropylene were bonded over a small proportion (<1%) of the surface area. The bonding can be achieved through the use of spray, spot or web glue patterns utilising standard or pressure sensitive glue agents. If utilised in the form of a bag the bonding of the laminate to the polypropylene may be restricted to the corners and margins of the bag.

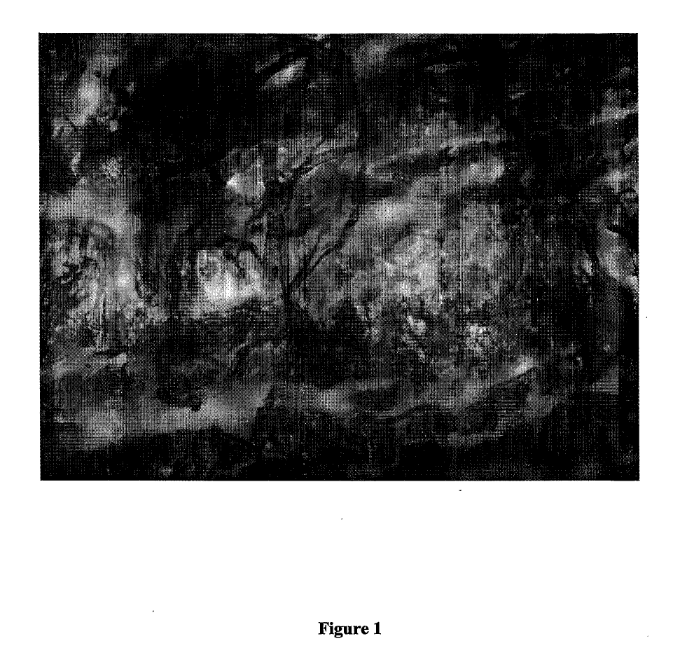

Prototype 2 was examined by light microscopy (FIG. 1). The tie layer appeared to cover almost all of the surface area of the BRL paper with only occasional holes or pits appearing where the cellulose paper was incomplete or stretched during the lamination process. It was estimated that the holes accounted for less than 0.01% of the surface area. It was noted that the polyethylene of layer 2 had impregnated into the cellulose structure of the paper layer rather than simply bonding onto the surface, such that cellulose fibres were embedded into the polyethylene. This provided a strong bond and would prevent de-lamination of the packaging material, in that de-lamination would require the tearing apart of the paper layer. However, the cellulose fibres did not penetrate right through the polyethylene of layer 2.

### Example 3

### Water Absorbency Characteristics of the Packaging Material of Prototype 2

The water absorbency of packaging material of the invention with four different water absorbent layers prepared as described in Example 2 (Prototype 2) were tested. From each of the four paper types, four 48 cm² pieces were cut and weighed. Each sample was then placed within a dry petri dish (positioned on a 45° angle) and slowly irrigated with water until complete saturation. Any excess water within the petri dish was drained and the paper samples were then re-weighed. Samples were transferred to a dry petri dish prior to re-weighing.

The BRL paper showed the highest amount of water absorption, and also the highest water absorption when expressed as a percentage of the water absorption of a corresponding control paper sample which was not bonded to any material (BRL, 66%; PCB, 44%; EGF, 54%; Beta2, 54%).

### Example 4

### Function of the Packaging Material in Protecting Produce

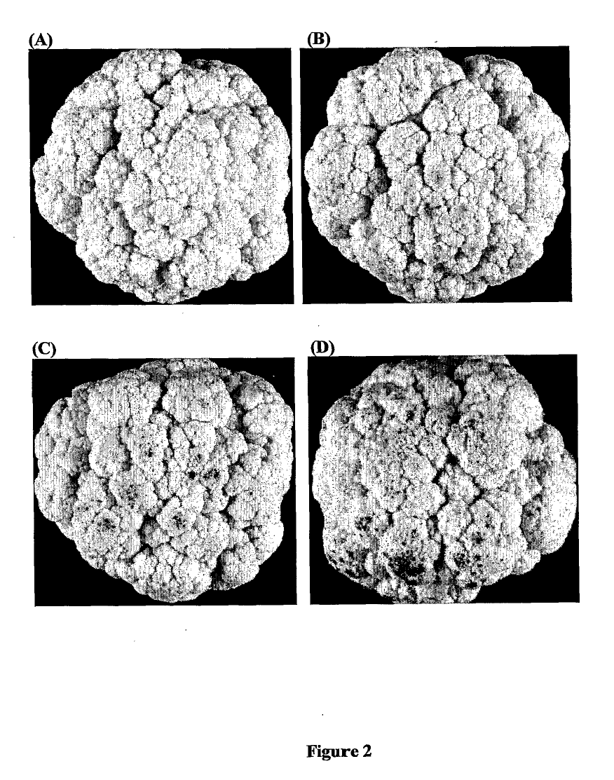

An initial experiment was carried out to assess the effect of temperature on cauliflower curd quality. Cauliflowers were deliberately injured either by bruising or by abrasion and then stored at a constant temperature of 20° C. or stored at 3° C. for 1 day and then transferred to 20° C. The incidence of curd blackening was scored as a visual quality index on a scale of 1 to 8. Examples of the severity scores of blackening for abraded cauliflower are shown in FIG. 2. A rating of 1 indicated no blackening while a rating of 8 indicated extensive blackening.

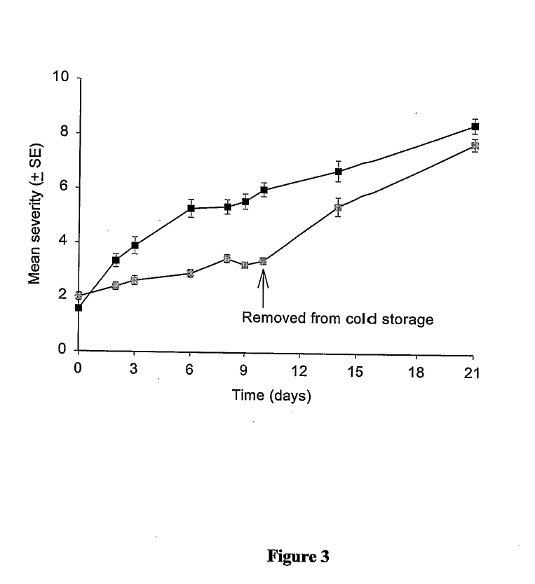

Cauliflower curd blackening was temperature and time dependant (FIG. 3). At 20° C. curd blackening occurred at a rapid rate. Blackening was significantly reduced by storage of the cauliflowers at 3° C. However, even at 3° C. when exposed to air (21% O₂), curd blackening was rapid enough to result in the cauliflower being unsaleable (severity rating of 4) after approximately 10 days. Once removed from cold storage, the curd blackening proceeded at a rate that was similar to the initial rate of the cauliflower stored at 20° C. (FIG. 3).

Prototype 1

In order to determine the effectiveness of the packaging material in protecting produce from moisture loss, experiments were carried out with cauliflower curds contained within either standard fibreboard cartons, waxed cartons or cartons lined with Prototype 1 described above. Freshly harvested cauliflowers were chilled to 3° C., weighed, wrapped in tissue paper and then stored at 3° C. in a cool room for 21 days in either of the following:
1. Standard fibreboard cartons, as used by the export cauliflower industry and supplied by Visy Board (Manjimup, Western Australia).
2. Waxed cartons supplied by Visy Board (Mildura, Victoria).
3. Prototype I lined carton which was prepared using a 50 micron polyethylene outer layer (layer 1), 2 ply absorbent cellulose paper (layer 3) which was glued to the polyethylene, and 16 gsm (grams per square metre) Spunbond polyethylene evolution fabric (layer 4).

The humidity and temperature within each box type was monitored with calibrated CS-500 relative humidity and temperature probes connected to a CR10X data logger. After 21 days of storage at 3° C., the cauliflowers were transferred to 25° C. For each treatment there were three replicate boxes, each of which contained 18 kgs of cauliflowers at the start of the experiment. Visual quality indexes and weights of each cauliflower were assessed at the start of the experiment and on days 7, 14, 21 and 26.

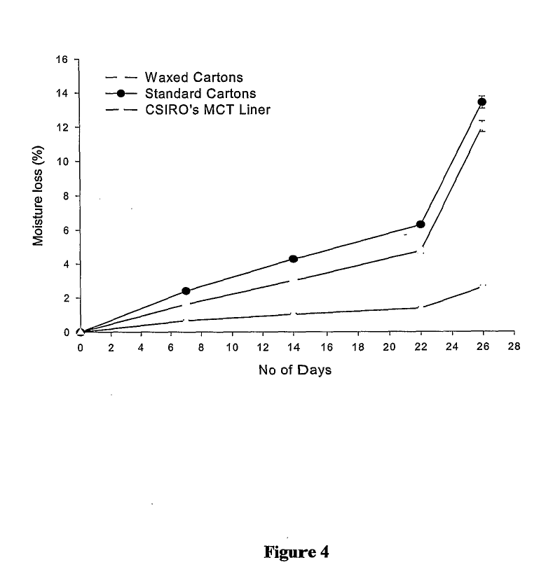

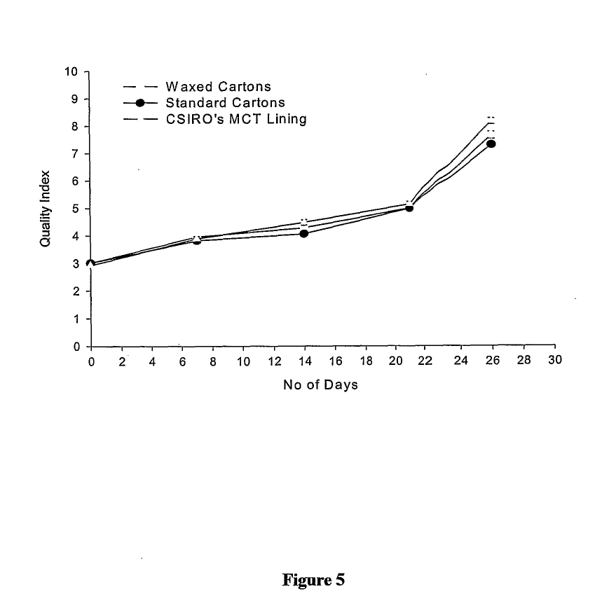

At 3° C., the mean relative humidity of the cool room was 75% and the mean relative humidity of the head space within cartons was 85% (standard fibreboard cartons), 87% (waxed cartons), and 95% (Prototype 1—lined cartons). Consistent with the differences in headspace relative humidity, there were large differences in moisture loss from the stored cauliflowers. Cauliflowers stored in standard fibreboard cartons at 3° C. lost 6.3% of their biomass over 21 days, those in waxed cartons lost 4.8% while those in the prototype 1 lined boxes lost only 1.4% (FIG. 4). There was no effect of box type on the visual quality index of the cauliflowers (FIG. 5). In conclusion, the liner effectively maintained a high (>95%), stable, relative humidity within the headspace of boxed cauliflowers and reduced moisture loss from the cauliflowers by 78% compared to standard fibreboard boxes and by 71% compared to waxed cartons.

Prototype 2

The present inventors compared two thicknesses of packaging liner (PE-cellulose) for maintaining relative humidity and temperature in boxes of produce in response to applied temperature abuse. Mature heads of cauliflower (Brassica oleracea variety ‘Chaser’) were harvested and temporarily stored at 3° C. during transport (<8 hours). Upon arrival to the laboratory, the cauliflowers were trimmed by removing green leaf material, individually weighed and placed into standard, non-waxed fibreboard cartons with or without Prototype 2 liner, which was either 20 gsm PE-cellulose with evolution fabric or 25 gsm PE-cellulose and evolution fabric (6 curds per carton). The cartons were removed from 3° C. storage every 3-4 days and stored at room temperature for approximately 4 hours. When returned to the cool room, a relative humidity and temperature probe was installed inside one carton from each treatment type. The wires from the relative humidity and temperature probes were extended to a CR10X data logger programmed to log sensor readings every 5 minutes. An additional relative humidity and temperature probe was located within the cool room.

Both types of PE cellulose were successful in maintaining high levels of humidity in response to applied temperature abuse. Relative humidity levels, within the lined cartons, consistently stabilized between 90-95% after room temperature storage, with the 25 gsm PE-cellulose liner having a higher relative humidity level by approximately 3%. Relative humidity levels within the non-lined cartons were 5-8% lower than that of the lined cartons, around 88%. These results indicate that the Prototype 2 liner was effective in preventing the diffusion of moisture from within the carton headspace to the storage atmosphere outside of the carton.

Short-term storage at 23° C. caused an increase in the temperature of both lined and non-lined cartons, through the accumulation of heat within the cauliflower curds and the carton fibreboard. When returned to cool storage, this heat dissipated and headspace temperatures within all carton types returned to approximately 3° C. Both types of PE-cellulose liners exhibited slightly slower rates of cooling then the non-lined cartons. During prolonged storage at 3° C., the Prototype 2 lined cartons maintained higher headspace temperatures than that of the non-lined cartons (3.4° C. compared to 2.6° C.).

Fresh weight loss, expressed as a percentage of initial fresh weight, was most pronounced in curds enclosed in the non-lined cartons. Cauliflowers from this treatment, on average lost between 33-68 g in fresh weight due to excessive water loss. Fresh weight loss in the Prototype 2 lined cartons was reduced by 60%, approximately 2.4% in curds enclosed in the 25 gsm PE-cellulose liner and 2.0% in curds enclosed in the 20 gsm PE-cellulose liner. Both types of PE-cellulose were effective in maintaining optimal storage conditions in response to temperature abuse, however the 25 gsm PE-cellulose was slightly more effective in maintaining relative humidity.

TABLE 3
Compression test parameters.

| | Compression Test 1 | | Compression Test 2 | |
|---|---|---|---|---|
| Probe Type: | 6 | mm Cylindrical | 20 | mm Cylindrical |
| Test type: | Hold at distance until time | | Hold at distance until time | |
| Compression | 4 | mm | 10 | mm |
| distance: | | | | |
| Hold time: | 2 | minutes | 2 | minutes |
| Probe speed: | 10 | mm/min | 10 | mm/min |
| Trigger force: | 0.04903 | N | 0.04903 | N |

In a further, similar experiment, the effect of using the Prototype 2 liner on turgidity of stored cauliflower was determined. Force testing was conducted three intact florets from each curd. Each sample was positioned on the base plate of a TA.XTPlus texture analyser so that the stalks of the florets were vertically aligned. Two compression tests were applied per floret and the upper and lower peak forces were recorded from each compression test (Table 3).

Table 4 shows the average force required to compress cauliflower florets to a specified distance (upper peak force) and average force exerted by florets in response to 2 minutes of held compression (lower peak force). Statistical analysis of the force testing results confirmed that there was a significant treatment effect and probe effect (5% significance level). Florets cut from curds stored within the Prototype 2 lined boxes had higher levels of turgidity than that of florets cut from curds stored within the non-lined boxes. Slight deformation of the florets (e.g. cracking of branches) was observed in the 20 mm probe compression tests.

TABLE 4
Average force required to compress cauliflower florets after
4 weeks storage in either Prototype 2 or non-lined cartons.

| | | | Upper Peak | Lower Peak |
|---|---|---|---|---|
| Probe Type | | Treatment | Force (N) | Force (N) |
| 6 | mm | Prototype 2 Liner | 21.08 | 12.50 |
| 6 | mm | No Liner | 14.02 | 9.10 |
| 20 | mm | Prototype 2 Liner | 83.81 | 47.17 |
| 20 | mm | No Liner | 70.99 | 40.43 |

These data show that use of the Prototype 2 liner significantly reduced fresh weight loss and improving post-storage quality of produce through the retention of curd turgidity and crispness.

### Example 5

### Influence on Postpacking Cool Down of Produce

To determine the effect of the packaging material liner on the post-pack cooling of produce, freshly harvested cauliflowers were individually weighed, wrapped in tissue paper and then packed (18 kg) into boxes which consisted of the following treatments:

1. Standard fibreboard boxes

2. Prototype 2 lined box with aeration holes closed

3. Prototype 2 lined box with aeration holes open

Headspace relative humidity inside each box was measured as before. T-type thermocouples were placed into the core of one cauliflower packed in the centre of each box, to monitor temperature changes. Adam-4018 units acquired data from the thermocouples which were then logged on a PC using Advantech VisiDAQ 3.10 software. The boxes of cauliflowers were allowed to cool to 3° C. and then at 3 day intervals were cycled through a series of temperature fluctuations. Temperature fluctuations were imposed by removing the boxes from the cool room, opening them, and allowing the cauliflowers to warm to 13° C. prior to being placed back in the cool room. Cooling rates were then calculated as the rate of change in temperature over time for the curd temperature range of 11 to 4° C.

At steady state temperature (3° C.), the mean headspace relative humidity was 87, 93 and 97% for standard fibreboard boxes, Prototype 2 boxes with aeration holes and Prototype 2 boxes without aeration holes, respectively. While the moisture loss from the Prototype 2 box without holes was significantly higher (2.8%) than in the previous experiment it was still 50% less than for the standard fibreboard box. Moisture loss from the box with Prototype 2, liner with holes was intermediate at 4.2%. Curd cooling rate was approximately 0.1° C. per hour and did not differ significantly between the 3 box types. This experiment indicated that the Prototype 2 liner without aeration holes provided superior humidity and moisture control without impacting on the cool down rate.

### Example 6

### Alternative Construction of Lined Boxes

The above-mentioned experiments involved boxes which were lined on the inside of both the base and the cover/outer sleeve of the boxes. However, because of brand name printing on the covers and the amount of liner used, incorporating the liner to the inside of covers might not be preferred. A suitable alternative to minimise the amount of liner used was to line the inner sleeve as before and then place a loose sheet of the liner over the produce, under the lid, rather than lining the cover/outer sleeve. These formats were compared, with standard fibre-board boxes as a control. The results showed that the box with inner sleeve lined and a loose fitting sheet placed on top of the produce was as effective as the fully lined box, both maintained a relative humidity of ˜95% compared to 87% for the standard fibre-board carton, and both reducing moisture loss by 75% compared to the standard fibreboard box.

### Example 7

### Effect of Wrapping Produce

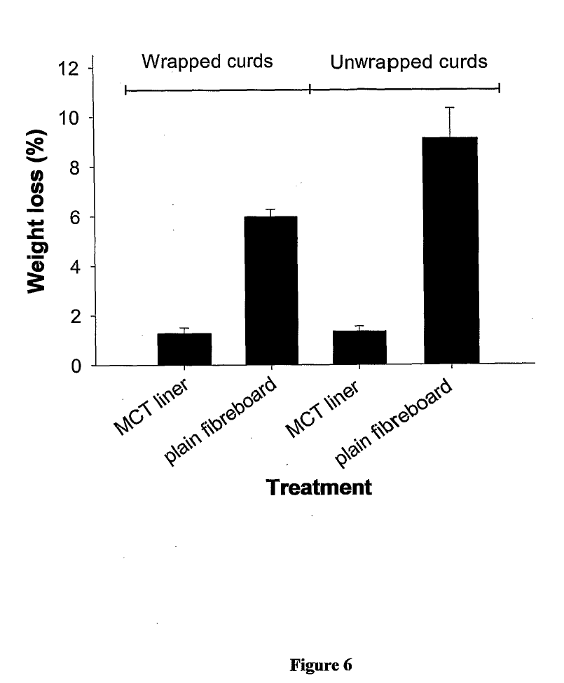

To determine whether wrapping of produce might further enhance the effect of the packaging material on reducing the moisture loss of produce, cauliflower curds were either wrapped in tissue paper or left unwrapped, and stored at 3° C. for 28 days in fibreboard cartons with or without a liner of Prototype 2. Moisture loss for wrapped or unwrapped curds was substantially reduced when the liner was used (FIG. 6). Wrapping of curds significantly reduced moisture loss from curds in standard cartons; but not to the extent of the reduction when the liner was used (FIG. 6). This experiment showed that the use of the liner did not require individual wrapping of the produce to reduce moisture loss. Furthermore, using the liner effectively substituted for, and was more effective than, wrapping alone.

### Example 8

### Testing Various Adhesives for Effectively Bonding the Water Absorbent Layer to the Layer Impermeable to Water vapour And Liquid Water

Eleven different types of glue were trialled using two application methods. In the first method, glue was evenly smeared onto the surface of the polyethylene piece before the cellulose layer was added. In the second method, glue was applied onto the surface of the polyethylene piece in straight lines. The ‘evolution fabric’ was then positioned on top of the cellulose layer, held in place by four blobs of glue (one blob in each corner of the square sample piece). All glues were left to dry for 24 hours before testing. Each type of glue was tested for bonding strength under both dry and wet conditions.

Under dry conditions, approximately 50% of the glues tested were successful in bonding the polyethylene, cellulose and ‘evolution fabric’ layers of the liner. Bonding strength was rated as being moderate to strong. Under wet conditions this percentage decreased, with only 30% of the glue types tested successful in retaining their bonding strength. In most instances, the cellulose layer could be pealed away from the polyethylene layer with little to no resistance. No bonding differences were found between the two application methods.

The greatest issue with using glue as a bonding method is its ability to bond the cellulose layer to the polyethylene layer. As a large proportion of glues require roughened surfaces for bonding to be effective, it is thought that the surface of the polyethylene layer is too smooth. Whilst the bonding of the polyethylene and cellulose layers may have been relatively successful under dry conditions, saturation of the polyethylene layer does reduce the effectiveness of glue as a bonding agent.

Options for gluing the cellulose polyethylene layers are limited by the inability of most glues to provide an effective bond under wet conditions. Accordingly, only two glues where found to be suitable for use in an adhesive layer of the present invention, namely i) Ibex Super Glue Gel which comprises alpha cyanoacrylate, and ii) Selley's Araldite Epoxy Resin (5 minute) which comprises a mixture of liquid epoxy and amine.

TABLE 5
Bonding capabilities of eleven different glue
types when tested under wet conditions.

| | | | Smear | |
|---|---|---|---|---|
| Name | Components | Description | application | Line application |
| Selley's | Polyvinyl | Fast, wet-grab | Bond is weak, | Bond is weak, |
| Stik-Back | Acetate | wallpaper glue. | cellulose and | only ‘evolution |
| | | | ‘evolution fabric’ | fabric’ can be |
| | | | can be easily | removed. |
| | | | pealed away from | |
| | | | the polyethylene | |
| | | | layer. | |
| Selley's | 96% high | Multipurpose | Bond is weak, | Bond is weak, |
| Urethane | bonding | adhesive; | ‘evolution fabric | ‘evolution’ fabric |
| Bond | Isocyanates | flexible, | and cellulose can | and cellulose |
| | | shockproof, | be easily pealed | remain bonded. |
| | | water, | away from the | |
| | | temperature | polyethylene | |
| | | and chemical | layer. | |
| | | resistant. | | |
| Magic | 500-550 mL/L | Bonds metal, | No bond between | No bond between |
| Hobby | Acetate | wood, leather, | any layers. | any layers. |
| Glue | | paper and most | | |
| | | plastics. | | |
| Weldbond - | Catalyzed | Bonds to | Bond is weak, | Bond is weak, |
| Space Age | polyvinyl | almost | cellulose and | cellulose and |
| Adhesive | acetate | anything. | ‘evolution fabric’ | ‘evolution fabric’ |
| | | | can be easily | can be easily |
| | | | pealed away from | pealed away from |
| | | | the polyethylene | the polyethylene |
| | | | layer. | layer. |
| Ibex | Alpha | Slow drying | Very strong bond | Very strong bond |
| Super | Cyanoacrylate | formula that is | between all three | between all three |
| Glue Gel | | water resistant. | layers. | layers. |
| Selley's | Polyurethane | A solvent- | Bond between | Bond between |
| Liquid | based | based synthetic | cellulose and | cellulose and |
| Nails - | adhesive | rubber contact | polyethylene | polyethylene is |
| Fast Grab | | type building | layers strong, | weakened and |
| | | adhesive. | although | ‘evolution fabric’ |
| | | | ‘evolution fabric’ | may be removed |
| | | | may be removed | easily. |
| | | | easily. | |
| Norton | Liquid | Bonds | Bond between | N/A |
| Contact | Hydrocarbons | laminated | cellulose and | |
| Cement- | and Methyl | plastics, wood, | polyethylene | |
| Industrial | Ethyl Ketone | metal, leather, | layers moderately | |
| Strength | | aluminium, | strong, although | |
| | | rubber and | ‘evolution fabric’ | |
| | | canvas. | may be removed | |
| | | | easily. | |
| Humbrol | N/A | For use with | No bond between | N/A |
| Poly | | styrene plastic. | any layers. | |
| Cement | | | | |
| UHU Stic | N/A | For use with | Very weak bond | N/A |
| | | paper, | between all three | |
| | | cardboard and | layers. | |
| | | photographs. | | |
| Selley's | Part A: 100% | Multi-purpose | Strong bond | N/A |
| Araldite | Liquid | adhesive. | between all three | |
| Epoxy | Epoxy | | layers. | |
| Resin - 5 | Part B: 8% | | | |
| minute | Amine | | | |
| Chemlube | N/A | Pressure | Bond between | N/A |
| New | | sensitive | cellulose and | |
| Contact | | contact | polyethylene | |
| Spray | | adhesive | layers moderately | |
| Adhesive | | suitable for | strong, although | |
| | | bonding a large | ‘evolution fabric’ | |
| | | range of | may be removed | |
| | | materials. | easily. | |

### Example 9

### Unsuccessful Prototypes for Transporting and/or Storing Perishable Goods

Numerous prototypes where prepared, before arriving at the claimed invention, using various processes which where found to be inadequate for transporting and/or storing perishable goods. These are described briefly below.

In one unsuccessful attempt, the polyethylene, cellulose and ‘evolution fabric’ layers were placed in a laminating pouch and fed through an automatic laminator, however, none of the three layers bonded.

In another unsuccessful attempt, the polyethylene, cellulose and ‘evolution fabric’ layers were positioned together between sheets of ‘butchers’ paper. A hot iron was then moved slowly over the surface area of the ‘butchers’ paper allowing heat to penetrate down through the three layers. Bonding of the three layers was not achieved, however the ‘polyethylene and evolution fabric’ layers did bond to the ‘butchers’ paper

In a further attempt, the use of a linear heat sealer was slightly successful in bonding the three layers. Whilst bonding was achieved between the polyethylene and ‘evolution fabric’ layers, it could not be reproduced after the middle cellulose layer had been added. It was also observed that the ‘evolution fabric’ was highly susceptible to tearing, particularly around those areas that had melted and bonded.

### Example 10

### Effect of Packaging Material on the Quality of Citrus Fruit During Simulated Storage

Citrus is an important crop that is exported primarily to markets in Asia and the United States of America. The primary post-harvest problems associated with cold storage and transport of citrus includes the loss of fruit moisture and the developmental expression of chilling injury. Both conditions limit profitability due to the loss of saleable weight and the reduced consumer appeal from decreased fruit turgidity and the symptomatic expression of sunken and often darkened rind lesions associated with chilling injury. The aims of this experiment were to test the effect of the packaging material fitted within fruit cartons for minimizing both fruit moisture loss and the subsequent developmental expression of chilling injury following cold storage.

The experiment was conducted using 24 cartons each containing 28 replicate navel oranges of cv. Lanes Late. Fruit within cartons were arranged in a factorial design to test the main effects of internal carton liner type (lined versus unlined) and storage at a 1 or 5° C. environment for 56 days before being transferred to a common observation room at 22° C. for 21 days. Fruit fresh weight and the incidence of chilling injury (rind break down) were assessed at 0 and 77 days from the start of the experiment. Chilling injury was scored based on the number of fruit affected per carton.

By the end of the experiment (day 77), liner type but not storage temperature had a significant effect on fruit moisture loss. Individual fruit held in cartons with MCT liners lost approximately 4.9 g±S.E.0.13 (1.7%) of moisture compared with 12.7 g±S.E. 0.34 (4.5%) for non-lined cartons over the 77 day period.

Chilling injury occurred within all treatments although the proportion of fruit with symptoms differed significantly between liner types but not between temperature treatments. By the end of the experimental period, approximately 6.6% of fruit in non-lined cartons exhibited symptoms of chilling injury whereas only 0.9% of fruit in MCT lined cartons displayed symptoms.

MCT-lined cartons significantly reduced fruit moisture loss and the developmental expression of chilling injury. This is due to the maintenance of a higher humidity level contained within MCT lined cartons versus unlined cartons. Chilling injury symptoms are often positively correlated with fruit moisture loss and thus the use of MCT liners can provide this dual benefit of not only maintaining fruit turgidity but also decreasing subsequent moisture loss leading to lower expression levels of chilling injury. In conclusion, the commercial use of the MCT liner system would be expected to lead to higher profits as a result of increased saleable fruit fresh-weights at out-turn and increased consumer demand for high quality fruit at the point-of-sale.

### Example 11

### Response of Cauliflowers to Modified Atmospheres

Three experiments were performed to determine the ideal storage atmosphere for cauliflowers. The first was designed to determine the influence of a range of oxygen concentrations from 0 to 21% on the development of curd blackening and consumer perception of quality during storage. The second experiment was designed to test whether low oxygen concentrations resulted in the formation of volatile compounds which may influence consumer perception of odour and taste. The third experiment was designed to test whether the presence of high CO₂ concentrations at low O₂ was detrimental to storage life.

Methods

Freshly harvested cauliflowers were defoliated and measurements were taken of weight, colour (by scanning with a Minolta Chroma Meter CR-200), and bruise severity. Cauliflowers were placed inside 110 litre containers and moist paper towel was used to line the base of the container to ensure high humidity. Perspex lids were clamped down to the rim of the containers and the containers were made airtight with a silicone seal. As acetic acid was released during the curing of the silicone and might influence the cauliflower physiology, the containers were flushed with humidified air (1 L min⁻¹) for the first 24 hours. During storage, containers were flushed daily with certified gas mixtures (Air Liquide). To avoid hypoxic shock, low O₂ treatments were applied incrementally. The minimum time between increments was 6 hours. This was a pulsing experiment where we aimed to maintain the O₂ and CO₂ concentrations to within 0.5% of specified values by regularly flushing the atmosphere within the containers.

TABLE 6
Certified gas mixtures used to maintain various
modified atmospheres inside 110 L containers.

| Treatment | Oxygen | Nitrogen | Carbon dioxide |
|---|---|---|---|
| 1 | 0% | 100% | 0% |
| 2 | 2.06% | 78.94% | 19% |
| 3 | 5.06% | 78.84% | 16.1% |
| 4 | 10.2% | 78.70% | 11.1% |
| 5 | 15.3% | 78.61% | 6.09% |

| | |
|---|---|
| 6 | Air atmosphere |

O₂ concentration was measured with a single KE-25 O₂ sensor in each container. Adam 4018 data acquisition modules were used to receive the mV outputs from each KE-25 O₂ sensor and data was logged using a PC running Advantech VisiDAQ 3.10 software. Raw data was later converted into O₂ concentrations from calibration curves developed for each sensor.

The atmosphere treatments were applied for 36 days at 3° C. followed by 5 days at 25° C. under air. A panel of consumers evaluated the cauliflower quality prior to and after 5 days storage at air atmosphere and room temperature. Treatment 1, which consisted of 0% O₂ was removed from the sensory evaluation, as cauliflowers stored under this treatment were rancid, and not suitable for consumption. Cauliflowers were weighed, scanned and assessed for bruise severity before consumer assessment.

Cauliflowers from each treatment group, as well as a repeated reference sample (Treatment 4=10% O₂) were displayed in a randomised order to the group of consumers. Consumers were asked to rate the overall appearance of the cauliflowers and then consider if they would purchase one if it appeared in the same condition in a supermarket.

20 g portions were then presented in a random order to the consumer group twice, initially raw and then cooked. Samples from each of the five treatments groups (2%, 5%, 10%, 15% and 21% O₂) plus a reference/repeated sample (10% O₂) was included. Consumers were asked to rank the samples on the basis of appearance, odour, flavour, texture and to give general comments where necessary.

Results

Prior to the start of the experiment, all cauliflowers had a quality index of less than 2 (excellent). Low oxygen concentrations greatly reduced the development of curd blackening. For example, after 36 days cauliflowers stored at 3° C. and 21% O₂ had severity scores of 8 and were unsuitable for export (cut off value for export was a severity score of 4). At 10% O₂ the severity of curd blackening was reduced by 50% and below 5% O₂ curd blackening was reduced by 70% relative to the 21% treatment. At this point the cauliflowers were still suitable for sale.

There was no significant difference in the quality of the deliberately injured (bruised and abraded) and control cauliflowers. Although the deliberately applied injuries were evident, there was a high degree of curd blackening due to background injuries. Interestingly, the cauliflowers stored at 0% O₂ appeared to be visually similar to those stored at 2% O₂. However, the cauliflowers stored at 0% O₂ had a very strong off-odour and so were excluded from any further involvement in the experiment. After the cauliflowers had been removed from the modified atmospheres and transferred to 21% O₂ and 25° C. curd blackening proceeded at a rapid rate and all cauliflowers were unsaleable within 5 days.

The quality data obtained for the duplicate samples (10% O₂) were not significantly different. However, unlike the initial visual assessment, the consumer panel did detect a significant difference in quality of cauliflowers stored at 2% compared to 5% O₂. Additionally, the consumer panel found that after exposure to 25° C. and 21% O₂ the appearance of the cauliflowers stored at O₂ concentrations of less than 10% were significantly better than those stored at 15 and 21% O₂. However the actual values (score=6) were much higher than the acceptable cut off point for marketing (score=4).

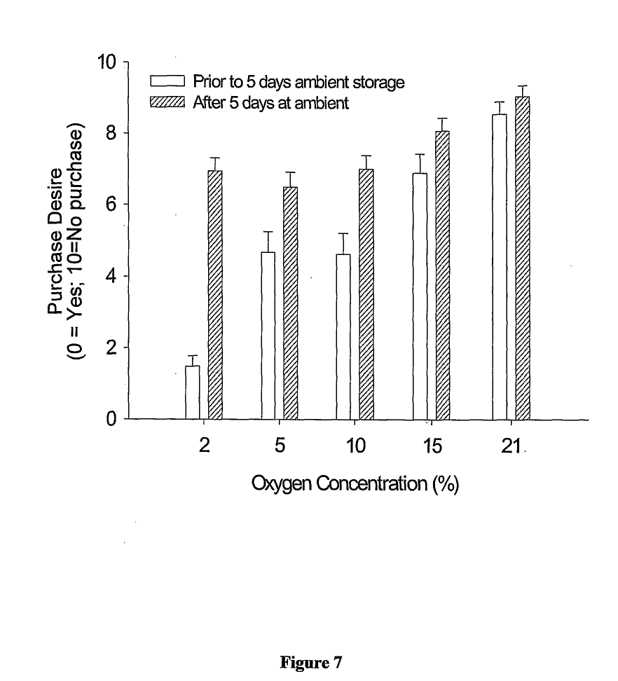

After the consumer panel had completed the visual quality assessment the cauliflowers were re-randomised and the consumer panel was asked to assess if they would purchase the cauliflowers that were displayed. In this case the consumer panel was allowed to handle the cauliflowers and smell them if they desired. Once again the consumer panel found no difference between duplicate samples as shown by a Students t-test (P=0.05) and there was a similar effect of O₂ concentration during storage on purchase desire (FIG. 7). Purchase desire and the visual assessment of quality were highly correlated (R2=0.97).

The consumer panel was not able to detect any significant effect of storage treatment on texture, taste and odour of both raw and cooked cauliflowers. Even when members of the panel were coached to specifically look for off odours they were unable to detect a treatment effect for randomised or trio-test arrangements. Furthermore, when the panel was given samples in order of treatments they were unable to detect if the order was ascending or descending or when the order was reversed.

### Example 12

### Formation of Volatile Compounds During Storage (Qualitative Assessment)

Methods

A small-scale experiment was carried out to determine the influence of O₂ concentration on the formation of volatile thiol compounds by cauliflowers. This experiment was conducted as a screen for potential odour forming compounds and was not intended as a quantitative assessment. Cauliflowers (variety Chaser) were harvested, leaves removed and the curds sectioned into florets (approximately 100 g each). The florets were sealed in 6 L containers (2 kg per container) which were fitted with KE25 O₂ sensor, control circuit boards and battery powered pumps. After a period of initial draw-down the O₂ concentrations were maintained by the pump system at 1, 2 and 21% O₂ and a 0% O₂ treatment was imposed by sealing one set of containers completely. There were three replicate containers for each O₂ concentration. After 10 days of storage the composition of volatile compounds in the headspace surrounding the cauliflowers was sampled by solid phase micro-extraction (SPME). Compounds were separated by gas chromatography and analysed by mass spectrometry (GCMS).

Results

Cauliflowers stored at 21% O₂ produce very few volatile compounds with only small amounts of beta-Myrcene and D-Limonene detected. At 2% O₂ octane and ethanol were evident at short retention times and ethylbenzene and methyl-butanol were detected at later retention times, 6.5 to 8.2 mins respectively. These compounds are not expected to have a strong influence on odour. At 1% O₂ an additional peak was detected with a retention time of 5.7 min which was likely dimethyl-disulphide. This compound may have an influence on odour. Several other sulphur containing (and hence potentially odoriferous) compounds were detected at 0% O₂ (Table 7).

It was noted that several small peaks occurred with retention times between 8.5 and 10.5 min. These compounds were not identified but may contribute to odour.

### Example 13

### Effect of CO₂ Concentration on Cauliflower Respiration and Quality

Method

Freshly harvested, “Prestige” cauliflowers were defoliated and stored in 110 L containers. Each container contained 16 cauliflowers, consisting of 8 bruised/abraded and 8 non-bruised cauliflowers, and moist paper towel to ensure a high humidity.

A perspex lid was sealed to the rim of the container with urethane foam tape and silicone. As acetic acid released from the curing silicone may influence the cauliflower physiology, the containers were flushed with air (1 L min−1) for the first 24 hours. Respiration was allowed to draw the O₂ concentration down to 2% and the O₂ concentration was thereafter maintained between 2.0 and 2.1% with an ES30 circuit board connected to a battery operated pump. Containers each had an inlet tube connected to the pump and a 1 m long outlet tube to allow mass flow but not allow the entry of O₂ by diffusion. Three containers had 500 g of soda lime in a receptacle to scrub CO₂, whilst the remaining three containers had no CO₂ scrubbing agent.

TABLE 7
Range of volatile compounds found in the headspace
around cauliflowers stored at 0, 1, 2 and 21% O2.

| Retention | | | | |
|---|---|---|---|---|
| Time (mins) | 0% | 1% | 2% | 21% |
| 2.1 | Octane | Octane | Octane | |
| 2.8 | Ethyl acetate | | | |
| 3.3 | Ethanol | Ethanol | Ethanol | |
| 5.8 | Dimethyl | Dimethyl | | |
| | disulfide | disulfide | | |
| 6.7 | Ethylbenzene | Ethylbenzene | Ethyl- | |
| | | | benzene | |
| 7.5 | beta-Myrcene | beta-Myrcene | beta- | beta- |
| | | | Myrcene | Myrcene |
| 7.9 | D-limonene | D-limonene | D- | D- |
| | | | limonene | limonene |
| 8.2 | 3-methyl | | | |
| | butanol | | | |
| 8.6 | Hexanoic acid | | | |
| | ethyl ester | | | |
| 10.6 | Dimethyl | | | |
| | trisulfide | | | |
| 10.8 | Hexanethioic | | | |
| | acid methyl | | | |
| | ester | | | |

O₂ consumption rates were measured with a single KE25 O₂ sensor in each container. Millivolt output from the sensors were received by ADAM-4018 units and logged with a PC computer running VisiDAQ software. CO₂ levels were monitored periodically with an ANRI-BM2 Portable Carbon Dioxide Monitor. Quality was assessed by a consumer panel before the experiment commenced, after 28 days storage at 2% O₂ with high or low CO₂ at 3° C., and after 5 days storage at room temperature and 21% O₂. This experiment consisted of two CO₂ levels (high and low) with 2 bruising treatments.

Results

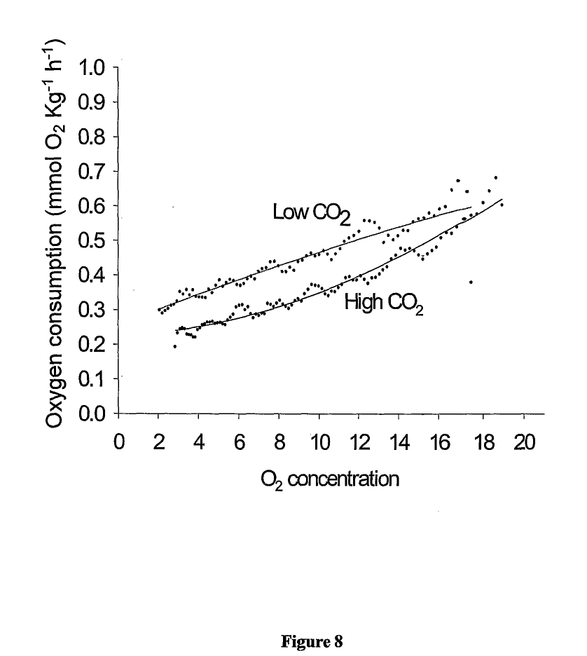

The influence of CO₂ concentration on cauliflower O₂ consumption (predominately respiration) was evident from very early in the experiment. FIG. 8 is a plot of O₂ consumption rate of cauliflowers during the draw-down of the O₂ within the container with high CO₂ (CO₂ concentration increases stoichiometrically with O₂ consumption) and the container with soda lime (low CO₂). The O₂ consumption rate at 20 to 21% O₂ was 0.6 mmol O₂ kg-1 cauliflower h-1. O₂ consumption rates declined as the O₂ concentration of the headspace decreased. However, the rate of decline was significantly greater for cauliflowers at high CO₂.

The O2 consumption rates for the low CO₂ cauliflowers were corrected for the influx of air through the 1 m length venting tube by mass flow which occurred due to the change in partial pressure of the atmosphere within the containers as O₂ was consumed and CO₂ was absorbed by the soda lime. At the steady state O₂ concentration of 2%, the O₂ consumption of the cauliflowers stored at high CO₂ was 42% less than the O₂ consumption of cauliflowers stored at low CO₂. At steady state (2.0 to 2.1% O₂) the O₂ concentration within the lime scrubbed containers was 1.0% and in the high CO₂ containers it was 18%.

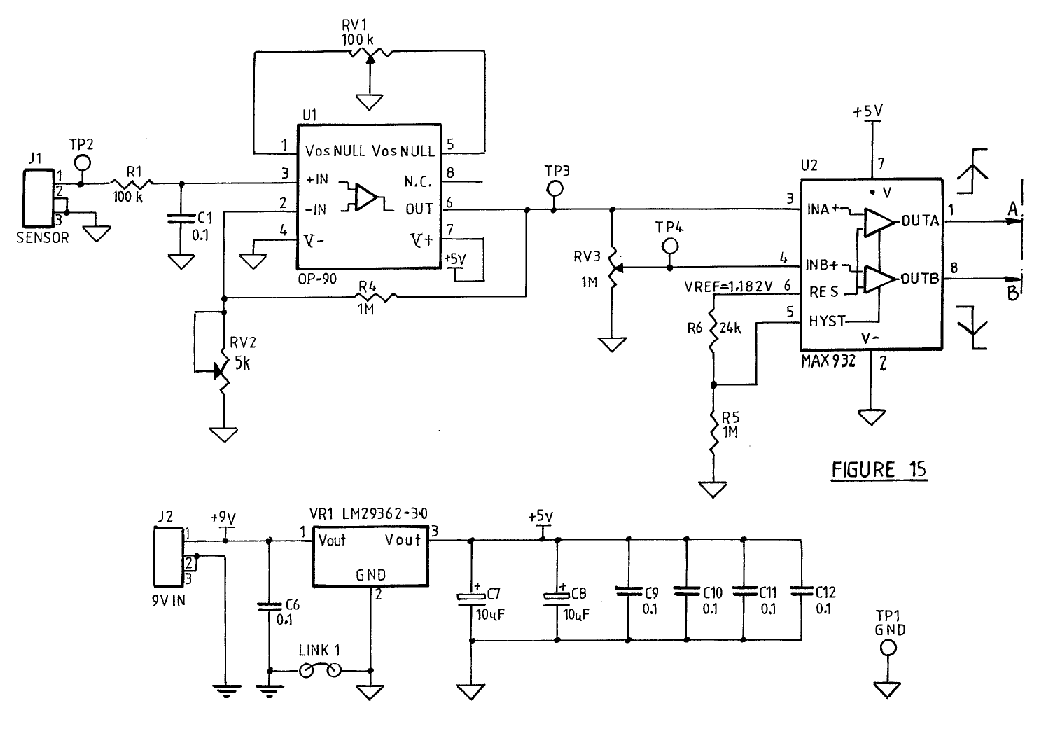

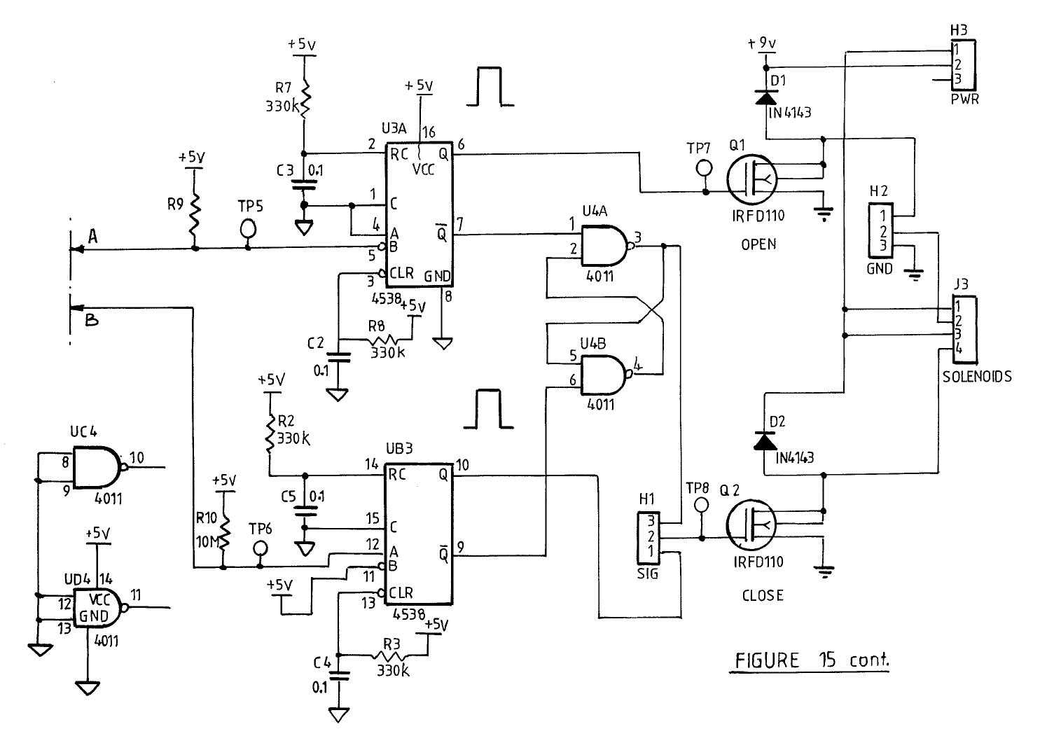

After 28 days of storage the consumer panel rated the high CO₂ cauliflowers at a quality index of 2.4 and the low CO₂ cauliflowers at 7.0. Hence, the high CO₂ cauliflowers were still suitable for the export market whereas the low CO₂ cauliflowers were unsuitable. This difference was also apparent after 5 days of storage at 21% O₂ and 25° C. (FIG. 15).

There was no discernable difference in odour or taste between the high and low CO₂ cauliflowers.

Conclusions from Examples 11 to 13

It was possible to reduce the incidence of curd blackening by up to 70% by storing cauliflowers at 2% O₂.

Other than the positive effect of low oxygen on quality, there was no discernable affect on sensory properties such as odour, taste and texture for both raw and cooked cauliflowers.

Curd respiration rate was dependent on O₂ concentration and at 2% O₂, respiration was 75% less than at 20 to 21% O₂.

Detailed analysis of headspace composition by GCMS indicates that at O₂ concentrations below 2% volatile thiol compounds were released which had the potential to influence odour. Compounds released at 2% O₂ and above were ‘non-thiol’ compounds and were unlikely to have a detrimental effect on odour.

High CO2 had a beneficial effect on cauliflower storage by inhibiting respiration and reducing the incidence/development of curd blackening.

### Example 14

### System for Controlling an Oxygen Concentration of an Enclosed Atmosphere Containing Respiring Produce

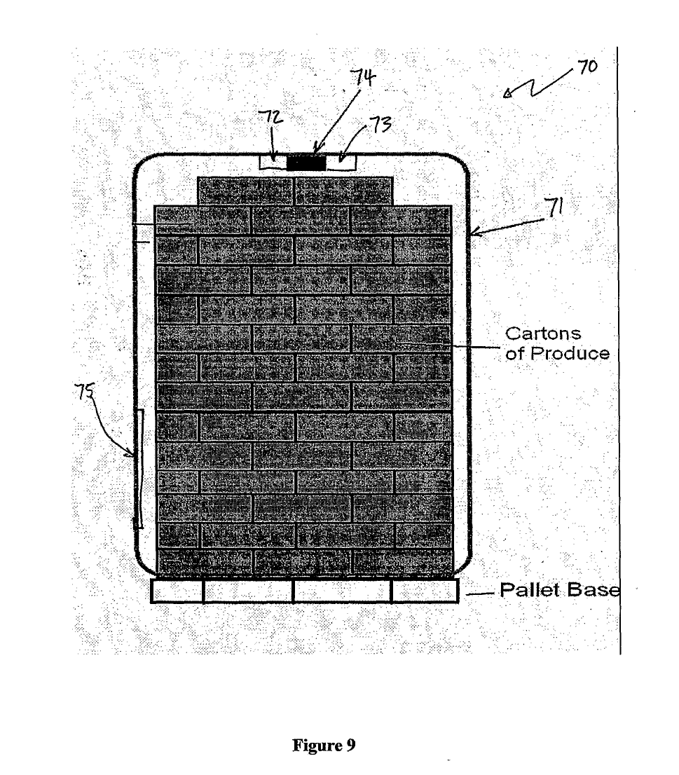

FIG. 9 illustrates a system 70 for controlling an oxygen concentration of an enclosed atmosphere containing respiring produce. System 70 comprises a polyethylene bag forming an enclosure 71 which isolates the enclosed atmosphere from an external atmosphere. The polyethylene bag has an opening large enough to enable the respiring produce to be stacked into the bag while on the pallet, and sides of the bag have been drawn up around the stacked produce and the opening sealed in order to form the enclosure 71.

The system 70 further comprises a KE-25 oxygen sensor 72 produced by Figaro USA, Inc, of 3703 West Lake Ave, Suite 203, Glenview, Ill., 60025, United States of America, for sensing the oxygen concentration of the enclosed atmosphere. The KE-25 oxygen sensor 72 is a galvanic cell-type sensor operable in the absence of a separate power source, and as such does not impose additional power requirements on a power supply of the system 70. The KE-25 oxygen sensor 72 provides an output voltage in the range of 0-15.5 mV which is representative of the oxygen concentration within enclosure 71. The output of the KE-25 oxygen sensor 72 provides a substantially continuous indication of the oxygen concentration, within the bounds of the electrochemical characteristics of the galvanic cell, with a typical 90% response time being around 14 seconds. This substantially continuous indication provides for a substantially immediate response to the oxygen concentration falling below the predetermined minimum concentration level or rising above the predetermined maximum concentration level, thus allowing the oxygen concentration to be maintained more closely to a desired level. The KE-25 oxygen sensor 72 also provides oxygen concentration measurements from 0% to 100% concentration to an accuracy of within 1%, and incorporates a thermistor for temperature compensation, allowing for use of sensor 72 in varying temperature conditions.

System 70 further comprises an air pump 73 for pumping the external atmosphere into the enclosed atmosphere within enclosure 71 to replenish the O₂ concentration by mass flow. The pump 73 is operated only when an oxygen concentration in the enclosed atmosphere falls below a predetermined minimum concentration. The pump 73 operates for only a portion of the time, and thus is implemented as a low power battery operated air pump requiring D-cell batteries or similar as a power supply. While in the present embodiment the pump requires six D-cell batteries due to low storage temperatures, other embodiments with application at higher temperatures such as room temperature may require only around two D-cell batteries. The very low cost of such a battery operated pump and D-cell batteries is a significant factor leading to the commercial viability of such atmosphere control techniques for storage of produce on a pallet scale. Examples of such air pumps include the Hagen battery air pump (1.5 V) and the Sonpar CP-900 portable battery pump. At room temperature such a pump is able to displace greater than 20,000 litres of air over 4 days using two D-cell batteries for power. To meet the respiratory requirements of a 750 kg pallet of cauliflowers for a 21 day period, a pump would be required to displace around 7000 litres of air.

Respiration of the produce within the enclosure 71 draws down the O₂ concentration to a predetermined minimum concentration. A controller 74 causes the pump 73 to commence operation when the oxygen concentration of the enclosed atmosphere within enclosure 71 is less than the predetermined minimum concentration, thus introducing external air into the enclosure 71 and introducing oxygen. The controller 74 then causes the pump 73 to cease operation when an oxygen concentration of the enclosed atmosphere exceeds a predetermined maximum concentration. Respiration then continues to draw the O₂ concentration down. Accordingly, system 70 allows the O₂ concentration to be maintained around the set point. Where the produce is cauliflower, a desired oxygen concentration level may be around 2%, and tests have shown the present system operates to maintain the oxygen concentration within 0.3% of that level.

A venting tube 75 allows mass flow of enclosed atmosphere out of the enclosure 71 during operation of the pump 73. The venting tube 75 is around 30 cm in length and around 4 mm in diameter, and is thus configured to allow mass flow of the enclosed atmosphere out of the enclosure 71, while limiting diffusion between the external atmosphere and the enclosed atmosphere. This provides a passive means to allow egress of the enclosed atmosphere from the enclosure 71 during operation of the pump 73, without requiring moving parts such as valves, and without requiring power operated parts. Avoiding moving parts provides for a more robust system, which is particularly advantageous where the storage system is for transportation storage of respiring produce. The venting tube 75 is configured such that diffusion between the external atmosphere and the enclosed atmosphere is limited to a rate less than a rate of respiration of the respiring produce in the enclosed atmosphere, such that the limited diffusion into the enclosed atmosphere does not cause a rise in oxygen concentration of the enclosed atmosphere. Indeed, such diffusion further reduces the time for which the pump 73 is required to be operated and thus further reduces the power requirements of the system 70.

The controller 74 is designed to be robust, with a minimal power consumption and with no moving parts. FIG. 15 is a circuit diagram for the controller 74 used in the system 70 shown in FIG. 9. While the output signal produced by the controller 74 is suitable for control of a solenoid valve, this signal may be used to produce a suitable control signal for a pump, or alternatively the output stages of controller 74 may be altered to produce such a signal.

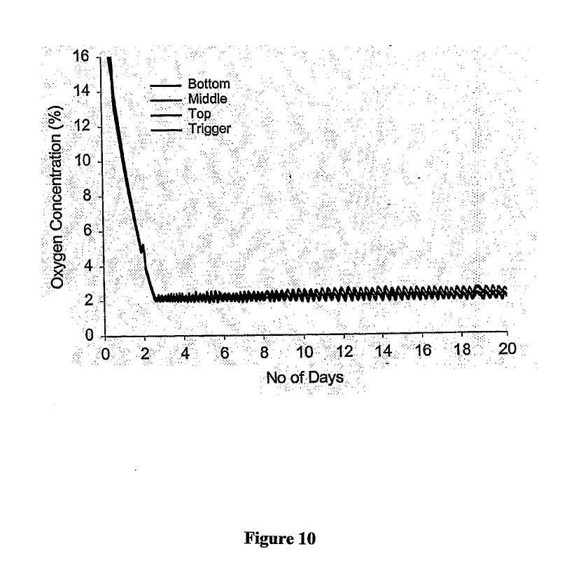

An example of the oxygen control given by the system in an enclosed pallet is shown in FIG. 10, showing the system to be successful at maintaining a given oxygen concentration within an enclosed pallet. The system with battery operated air pump therefore maintains a desired oxygen level within a tented pallet and is suitably simple and low cost.

### Example 15

### Combined Moisture and Atmosphere Control Technologies

Experiments were carried out to determine if the prototype 2 liner and the oxygen controller as generally described in Example 14 could be used in combination to improve the quality of stored produce. These aimed to compare the quality and moisture loss from cauliflowers stored within either standard fibreboard boxes or prototype 2 lined boxes which were either located in a tented pallet at 2% O₂ and 3° C. or outside the tented pallet at 21% O₂ and 3° C.

Method

Two experiments were conducted, both consisted of half-sized pallets (containing approximately 250 kg of cauliflowers var Chaser) fitted with an oxygen controller which used the battery powered pump to maintain a stable O₂ concentration at 2%, O₂. In both experiments six boxes of cauliflowers were also stored in the coolroom on the outside of the tent. Within the tented pallet there were three layers of boxes, most of the boxes were prototype 2 lined however there were three standard fibreboard boxes, one of which was located on each layer of the pallet. Assessments of moisture loss and quality were performed on:
The three standard fibreboard boxes within the pallet (one from each layer).
Three prototype 2 lined boxes within the pallet (one from each layer)
Three standard boxes stored outside the pallet.

Three prototype 2 boxes stored outside the pallet.

The O₂ control for the pallet was based on the output for a single O₂ sensor located at the top of the pallet. Air from the pump was delivered by a tube which ended approximately 20 cm away from the O₂ sensor.

Additional O₂ sensors were placed outside the cartons (within the tented pallet) in the middle of each layer of boxes. O₂ sensors were also placed in the headspace of one prototype 2 lined and standard carton per layer. Three temperature and relative humidity probes were placed within the pallet; one probe was located outside the boxes on the top layer, one was located within a prototype 2 lined box on the top layer and the other was located within a standard carton on the top layer.

Results

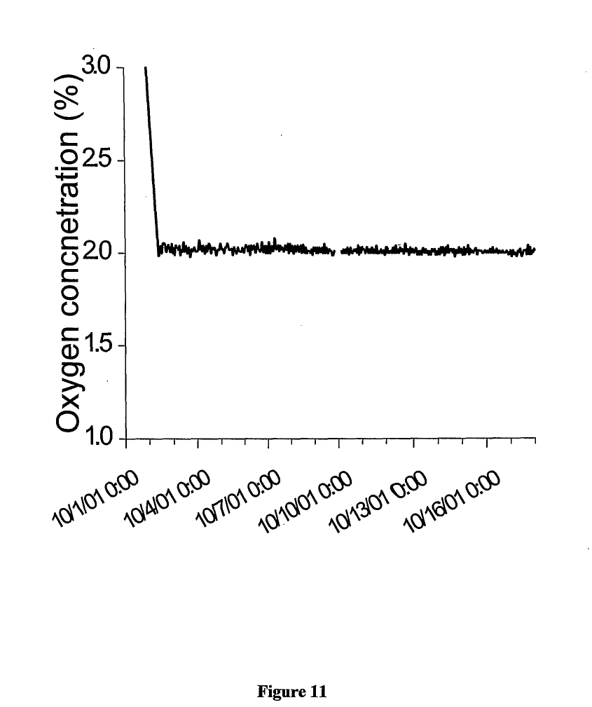

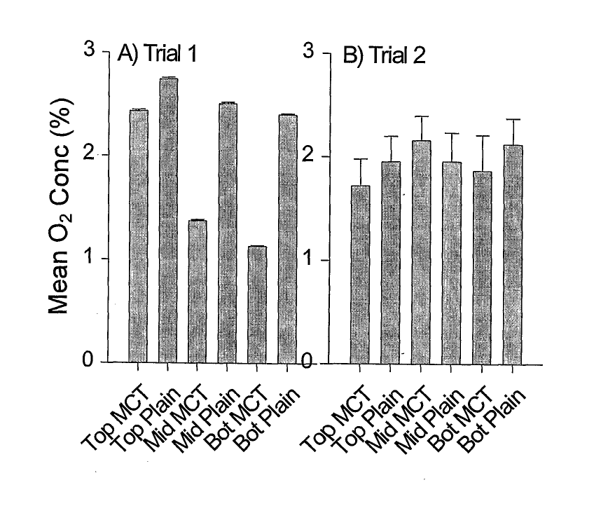

In both experiments the atmosphere control technology maintained a stable O₂ concentration of approximately 2.0% (for example, see FIG. 11). In both experiments there was no apparent O₂ concentration gradient in the atmosphere surrounding the boxes within the pallet. Likewise, there was no significant difference in the O₂ concentration of the atmosphere within the headspace among the standard fibreboard cartons and there was no significant difference between the O₂ concentration within the fibreboard cartons and the atmosphere surrounding them. However, in experiment 1 the prototype 2 lined boxes in the middle and lower layers had significantly lower O₂ concentrations than the prototype 2 lined boxes on the top layer, the standard fibreboard boxes and the air surrounding the boxes (FIG. 12). The weight of the boxes in the top layer provided sufficient force to push the prototype 2 liner bonded to the outer sleeve of the carton onto the prototype 2 liner bonded to the base of the carton forming a partial seal and inhibiting the diffusion of oxygen into the cartons. In experiment 2 the prototype 2 lined boxes were half-lined with a loose fitting sheet of laminate over the surface of the produce, beneath the outer sleeve. There was no difference in O₂ concentration of the atmosphere within the prototype 2 lined boxes in experiment 2 and the remainder of the tented pallet (FIG. 12).

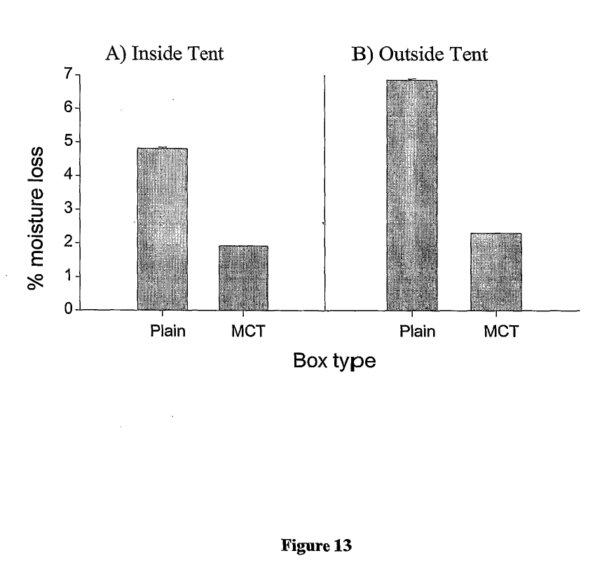

The treatment effects on moisture loss were similar for the first and second experiment. In the second experiment, cauliflowers stored in the standard cartons (“Plain”) outside the tent lost 7% of their weight whereas those stored in prototype 2 lined cartons (“MCT”) lost 2% of their weight. Moisture loss from cauliflowers stored inside the tented pallet was 5% for the cauliflowers in standard boxes and 1.8% for cauliflowers in prototype 2 boxes (FIG. 13).

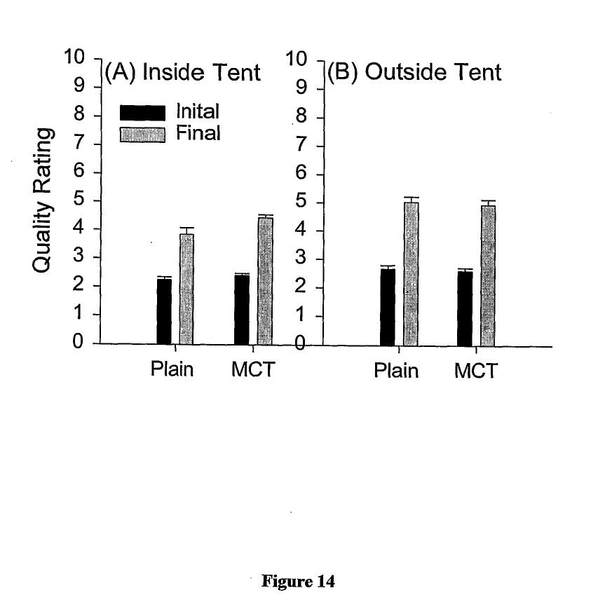

Quality was assessed immediately after storage and the effect of treatments on quality index was similar for both experiments. As such, data are presented for the second experiment only. At the start of experiment the cauliflowers had a mean quality index score of 2, after 26 days the quality index of the cauliflowers stored outside the tented pallet was 5.1 regardless of whether the cauliflowers were contained in prototype 2 lined boxes or standard fibreboard boxes. The average quality index of cauliflowers stored within the tented pallet was 4.2 and there was no significant difference in the quality of the cauliflowers contained within the prototype 2 lined boxes or the standard fibreboard cartons (FIG. 14).

It can be concluded that the oxygen controller accurately maintained the desired O₂ concentrations and there was no apparent gradient in O₂ concentration within the tented pallet, except the low O₂ concentration recorded within the fully-lined prototype 2 boxes in experiment 1. The fully-lined prototype 2 boxes could inhibit O₂ diffusion, which in a low O₂ environment might result in a significant reduction in O₂ concentration within the prototype 2 box, but this did not occur for half-lined prototype 2 boxes. Moisture loss from the prototype 2 boxes was 70% less than from standard fibreboard boxes.

### Example 16

### Tests of Moisture Control Liner Under Export Conditions

Experiments were carried out to determine if the moisture control liner was effective to improve the quality of stored produce under export conditions. The first trial involved the export of cauliflowers from Western Australia to Singapore including an assessment of curd quality and fresh weight loss after 12 days of storage. Freshly harvested cauliflowers were defoliated, weighed and were either stored in fibreboard cartons with or without the moisture control liner (MCT, prototype 2). After 24 hours of cool storage, the cartons were randomly packed within pallets and were loaded onto a shipping container refrigerated to 1° C. The cartons were then transported via 10 days of sea freight to Singapore. A relative humidity and temperature logger was installed inside one carton from each treatment type. The output from the loggers was logged every 10 minutes.

The internal temperature of the shipping container was maintained at 0.3° C. for the duration of the journey. The average storage temperature was higher in the MCT lined cartons (approximately 0.6° C.) than in the non-lined cartons (0.3° C.). The level of humidity within the shipping container was approximately 7% lower than that of the fibreboard cartons. No significant difference in relative humidity was recorded between the MCT lined and non-lined cartons. These conditions were close to the best possible under current practices used for export, and expected to result in high quality produce even in the non-lined cartons.

Cauliflower curds from the MCT-lined cartons lost 0.94±0.04% weight compared to 1.90±0.10% weight lost from the non-lined cartons. Therefore, use of the MCT liner halved water loss compared to cauliflowers stored without the liner, despite the conditions being close to ideal for the non-lined produce. Moreover, curd quality at out turn as assessed by qualified staff was higher from MCT lined cartons than from unlined cartons. Curds from MCT lined cartons were more turgid, appeared fresher and appeared to have a whiter appearance than curds from unlined cartons.

### Example 17

### Tests of Moisture Control Liner Under Export Conditions—Citrus

A further trial tested the ability of the MCT liner to minimize rind disorders and fruit moisture loss from citrus exported from Australia to the United States. The Australian citrus industry is prone to significant economic losses due to fruit rind breakdown and moisture loss occurring during cold storage and transport. Unfavourable fruit quality parameters that may occur include fruit moisture loss, an associated reduction in fruit firmness, fruit deformation and the expression of rind disorders such as chilling injury.

The experiment was conducted using 50 cartons each containing 72 Washington navel oranges and packed as part of a standard pallet containing 70 cartons. Half of the cartons were lined with the MCT liner while the other half were packed without a liner. Cartons were arranged in a randomised block design with the pallet layers being representative of blocks. Fruit were packed at a citrus packing facility in north-western Victoria, Australia and shipped without delay by ocean vessel from Adelaide to San Diego, USA as part of a 3000 pallet consignment. The pallet arrived in San Diego after approximately three weeks and was placed in cool (6° C.) storage for a further three weeks. Fruit quality was assessed at the end of this three week cool storage period.

The air temperature and relative humidity (RH) were recorded in the cartons throughout the study. The mean internal carton air temperature differed little between liner types during shipping, averaging about 2.7° C. During the subsequent cool storage period, the average temperature in the cartons ranged between 5.5 to 6° C. The RH of airspace in unlined carton reflected the ambient conditions, averaging 90% during shipping and 85% during cool storage. Fruit in the MCT liners, however, averaged a RH of 100% throughout the duration of the experiment.

At the end of the experiment, fruit in the unlined cartons had lost on average approximately 0.5 kg in weight, representing loss of moisture, compared to a loss of approximately 0.06 kg of water per MCT-lined carton, from an initial average carton weight of 16.6 kg. Fruit in the MCT-lined cartons were also significantly (17%) firmer than those from the unlined carton. Chilling injury, oleocellosis and albedo breakdown were also determined for fruit from both types of cartons. The incidence and severity of chilling injury and albedo breakdown were significantly higher in the unlined cartons, whereas no differences were found in levels of oleocellosis between the treatments.

It was concluded from this export trial that the MCT liner provided significant benefits over the use of conventional unlined cartons. This included significant reductions in fruit moisture loss, increased fruit firmness and an overall reduction in rind breakdown disorders, such as chilling injury and albedo breakdown. The absence of effect on the level of oleocellosis was not surprising considering that this is a pre-harvest condition. Interestingly, the observation that albedo breakdown, also a pre-harvest condition, was reduced with the use of the MCT liner suggested that the liner probably inhibited moisture loss from the disorder zone, which may be an important element in the expression of this disorder. A high level of relative humidity within the cartons throughout the study would have provided this optimum environment for inhibiting moisture loss from the fruit.

### Example 18

### Tests of Moisture Control Liner for Use with Grapes

A further experiment was carried out to test use of the liner with stored table grapes. Current industry practice involves use of a plastic bag inside a fibreboard or polystyrene carton. This experiment therefore compared cartons having the conventional plastic bag with cartons having a MCT liner. Sulphur-dioxide emitting pads are often used to extend the storage life of the fruit by preventing post-harvest diseases such as botrytis rot, and so were also used in the trial. They may, however, have some disadvantages. Use of these pads can cause sulphur damage which softens and bleaches the fruit. Moreover, sulphur pads need to be replaced if the period of storage and transport exceeds 8-10 weeks.

The containers used in the trial were dense polystyrene foam with holes to enable cooling throughout. The grapes (Red Globe) were harvested less than 4 hours prior to packing and were not prechilled before packing. All containers were packed by staff on the commercial packing line at the grower's packing shed. Eight treatments were carried out with 3 replicates for each, as follows:

TABLE 8
Prechilling and SO₂ storage conditions for packaged grapes

| | Liner | | | | | | | |
|---|---|---|---|---|---|---|---|---|
| | Control liner (plastic bag) | | | | MCT liner | | | |
| SO₂ pad | 0 | 0.5 | 1 | | 0 | 0.5 | 1 | |
| Prechill temp | 0° C. | 0° C. | 0° C. | 4° C. | 0° C. | 0° C. | 0° C. | 4° C. |

Half of the cartons contained the standard plastic liner and the other half contained the MCT liner. The amount of sulphur-dioxide pad (UVASYS green) was varied to determine how much would be required. The current industry standard is one full sulphur pad per 10 kg box. The prechilling temperature was standard at 0° C., but many growers have difficulty in obtaining the reduced temperature before packing, hence a 4° C. prechill temperature was included for comparison.

Cartons were weighed after overnight prechilling at 0° C. or 4° C., and then after 10 and 20 weeks of storage. Fruit were then graded, with the number of bunches counted in each fruit grade: A: perfect fruit, B: rare damage, C: medium damage, D: high damage. Fruit from each grade was divided into individual berries and assigned to damage type categories: good fruit, sulphur damage fruit, fruit with black spots, fruit with botrytis rot, and fruit with mould. Fruit from these damage type categories were weighed to provide the proportion for each damage type, as well as to enable calculation of weight of overall good and bad fruit. Furthermore, the quality of the bunch stems was observed to determine if they were of marketable quality. As the presence of a sulphur pad extends storage life by inhibiting mould growth, the cartons with no sulphur pad were evaluated at 10 weeks storage, while all those with sulphur pads received full evaluation at 20 weeks.

It was observed that the MCT-lined cartons generally had a lower volume of bad quality fruit (Table 9). However, stem browning was greater in the MCT-lined cartons, mostly in the top layer of the cartons, perhaps because the MCT liners as used did not provide an airtight seal. Overall, the results were positive.

TABLE 9
Comparison of table grape quality after
storage with conventional or MCT liner.

| | | Prechill | % unacceptable | Standard |
|---|---|---|---|---|
| Liner | SO₂-pad | Temperature (° C.) | fruit | Error |
| plastic | 0 | 0 | 54.6 | 7.8 |
| plastic | 0.5 | 0 | 22.9 | 2.1 |
| plastic | 1 | 0 | 35.3 | 6.2 |
| plastic | 1 | 4 | 39.5 | 10.0 |
| MCT | 0 | 0 | 26.1 | 4.3 |
| MCT | 0.5 | 0 | 32.3 | 4.4 |
| MCT | 1 | 0 | 22.3 | 8.4 |
| MCT | 1 | 4 | 17.8 | 1.9 |

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

All publications discussed above are incorporated herein in their entirety.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

1-94. (canceled)

95. A process for the manufacture of a packaging material, the process comprising
(i) applying a tie layer of molten polyolefin to a water-absorbent layer,
(ii) optionally exposing the product of (i) to pressure,
(iii) applying an outer layer of polyolefin to the tie layer,
(iv) exposing the product of (iii) to pressure, and
(v) allowing the material to cool,
wherein the tie layer of polyolefin partially impregnates the water-absorbent layer.

96. A process according to claim 95, wherein the outer layer is molten when applied.

97. A process according to claim 95, wherein the polyolefin is selected from the group consisting of polyethylene, polyvinylchloride, polypropylene, or mixtures thereof.

98. A process according to claim 95, wherein the outer layer, the tie layer or both the outer layer and the tie layer further comprise at least one additive selected from the group consisting of a colour agent, an adhesive, a surface slip agent and mixtures thereof.

99. A process according to claim 95, wherein the outer and tie layers have the same composition.

100. A process according to claim 95, wherein the tie layer has a thickness of from about 5 to about 10 microns.

101. A process according to claim 95, wherein the outer layer has a thickness of from about 15 to about 30 microns.

102. A process according to claim 95, wherein the outer layer, the tie layer or both the outer layer and the tie layer is/are applied by extrusion and/or pressure is applied by passing the layers through a nip point and the outer and tie layers form a solid proximal to, or at, the nip point.

103. A process according to claim 95, wherein the pressure is from about 400 to about 800 kPa.

104. A process according to claim 95, wherein the outer layer, the tie layer or both the outer layer and the tie layer of molten polyolefin has a temperature of from about 200° C. to about 300° C.

105. A process according to claim 95, wherein step (v) comprises passing the material over a series of rollers, and then winding the material on a reel.

106. A process according to claim 95, wherein the process further comprises bonding a water vapour-permeable inner layer to the water-absorbent layer, wherein the water vapour-permeable inner layer is substantially impermeable to liquid water in the water-absorbent layer.

107. A process according to claim 106, wherein the inner layer is bonded to the water-absorbent layer over less than 5% of the surface area of the inner layer.

108. A packaging material comprising
(i) a liquid water- and water vapour-impermeable outer layer,
(ii) a water-absorbent layer,
(iii) a tie layer bonded to the outer layer and the water-absorbent layer, and
(iv) a water vapour-permeable inner layer which is substantially impermeable to liquid water in the water-absorbent layer,
wherein the tie layer partially impregnates the water-absorbent layer.

109. A packaging material according to claim 108, wherein the water vapour-permeable layer is bonded to the water absorbent layer.

110. A packaging material according to claim 108, wherein the outer layer comprises a petrochemical- or plant-derived organocarbon.

111. A packaging material according to claim 110, wherein the organocarbon is a polyolefin selected from the group consisting of polyethylene, polyvinylchloride, polypropylene and mixtures thereof.

112. A packaging material according to claim 108, wherein the outer layer and the tie layer comprise a polyolefin selected from the group consisting of polyethylene, polyvinylchloride, polypropylene and mixtures thereof.

113. A packaging material according to claim 112, wherein the outer layer, the tie layer or both the outer layer and the tie layer further comprise an additive selected from the group consisting of a colour agent, an adhesive, a surface slip agent and mixtures thereof.

114. A packaging material according to claim 108, wherein the outer layer and tie layer have the same composition.

115. A packaging material according to claim 108, wherein the tie layer has a thickness of from about 5 to about 10 microns.

116. A packaging material according to claim 108, wherein the outer layer has a thickness of from about 15 to about 30 microns.

117. A packaging material according to claim 108, wherein the outer layer contacts at least 90% of a surface of the tie layer.

118. A packaging material according to claim 108, wherein the water-absorbent layer contacts at least 90% of a surface of the tie layer.

119. A packaging material according to claim 108, wherein the water-absorbent layer is able to adsorb at least 50 g of water per m².

120. A packaging material according to claim 108, wherein the water-absorbent layer comprises cellulose fibres.

121. A packaging material according to claim 108, wherein the water-absorbent layer has a specific weight of from about 15 to about 30 g/m².

122. A packaging material according to claim 108, wherein the water-absorbent layer has a thickness of from about 60 to about 95 microns.

123. A packaging material according to claim 108, wherein the water-absorbent layer has a machine direction tensile of from about 15N/75 mm to about 35N/75 mm.

124. A packaging material according to claim 108, wherein the water-absorbent layer further comprises a bioactive molecule, or a precursor thereof where the bioactive molecule is released upon exposure to water.

125. A packaging material according to claim 124, wherein the bioactive molecule is selected from the group consisting of SO₂, 1-methylcyclopropene and a mixture thereof.

126. A packaging material according to claim 108, wherein the inner layer comprises hydrophobic polyolefin.

127. A packaging material according to claim 126, wherein the hydrophobic polyolefin is a spun-bond polypropylene.

128. A packaging material according claim 108, wherein the inner layer is bonded to the water-absorbent layer over less than 5% of the surface area of the inner layer.

129. A packaging material comprising
(i) a liquid water- and water vapour-impermeable outer layer,
(ii) a water-absorbent layer, and
(iii) a water vapour-permeable inner layer which is substantially impermeable to liquid water in the water-absorbent layer,
wherein the water-absorbent layer comprises cellulose fibres and has a specific weight of from about 15 to about 30 g/m² and a thickness of from about 60 to about 95 microns, and wherein the water vapour-permeable inner layer is bonded to the water-absorbent layer.

130. A packaging material produced according to claim 108, further comprising a supporting layer that provides mechanical strength and which contacts the outer layer.

131. A packaging material according to claim 130, wherein the supporting layer is a corrugated paper carton.

132. A method of storing and/or transporting a perishable product, the method comprising inserting the product into, or substantially wrapping the product with, packaging material according to claim 108.
